(19) United States
(12) Patent Application Publication
(10) Pub. No.: US 2018/0161722 A1
(43) Pub. Date: Jun. 14, 2018

(54) HYGROSCOPIC MATERIAL, METHOD OF PRODUCING SAME, AND PACKAGING MATERIAL

(71) Applicant: FUJIFILM CORPORATION, Tokyo (JP)

(72) Inventor: Takeo KIDO, Shizuoka (JP)

(21) Appl. No.: 15/891,379

(22) Filed: Feb. 8, 2018

Related U.S. Application Data
(63) Continuation of application No. PCT/JP2016/075893, filed on Sep. 2, 2016.

(30) Foreign Application Priority Data
Sep. 30, 2015 (JP) 2015-195271

(51) Int. Cl. B01D 53/26; B01D 53/28; B01J 20/04; B01J 20/10; B01J 20/28; B01J 20/30; B32B 5/14; B32B 3/30

(52) U.S. Cl. CPC B01D 53/263; B01D 53/28; B01J 20/046; B01J 20/103; B32B 27/20; B01J 20/3007; B32B 5/145; B32B 3/30; B01J 20/28047

(57) ABSTRACT

Provided is a hygroscopic material including: a support which contains a resin having moisture permeability and has roughness in at least one surface thereof; a hygroscopic layer which is disposed in recesses of the at least one surface of the support; and a damp-proof layer which is disposed on one surface of the support, on which the hygroscopic layer is disposed.

### CROSS-REFERENCE TO RELATED APPLICATION

This application is a continuation application of International Application No. PCT/JP2016/075893, filed Sep. 2, 2016, the disclosure of which is incorporated herein by reference in its entirety. Further, this application claims priority from Japanese Patent Application No. 2015-195271, filed Sep. 30, 2015, the disclosure of which is incorporated herein by reference in its entirety.

### BACKGROUND OF THE INVENTION

### 1. Field of the Invention

The present invention relates to a hygroscopic material, a method of producing the same, and a packaging material.

### 2. Description of the Related Art

In a dried product such as food or medicine, in order to maintain the humidity inside the packaging to be low so that the contents are protected from the moisture in the air, a small bag or the like that contains a desiccant such as silica gel is usually packed inside the packaging. This packaging is carried out by putting a dried product in a bag-like packaging material, putting a small bag containing a desiccant therein, and sealing the bag-like packaging material. Since a process of putting a small bag containing a desiccant is a process different from a process of putting essential inclusions, this process is usually automated, but the packaging process may become complicated in some cases. Further, in a case of food such as confectionary, a desiccant is enclosed in the food. Therefore, there is a concern that a desiccant is accidentally mixed with the food or a desiccant is accidentally ingested due to breakage of a small bag or the like.

Due to this concern, a film containing a desiccant which can be used as a packaging material has been suggested in place of the small bag containing a desiccant. For example, a desiccant-mixed film formed by kneading a powdery desiccant such as a molecular sieve with a resin has been suggested, and an aspect in which a desiccant-mixed film and a gas barrier film are laminated on each other is disclosed as an aspect for use (for example, see JP3919503B).

In a laminated film of a desiccant-mixed film and a gas barrier film, it is difficult to achieve a desired hygroscopic capacity and maintain an excellent hygroscopic capacity for a long period of time in some cases due to infiltration of moisture from an end portion of a film to a hygroscopic layer.

For this reason, in order to suppress moisture absorption from an end surface, a packaging material that suppresses moisture permeation by reducing the thickness of a sealant portion of an end portion of the packaging material has been suggested (for example, see JP4450932B). Further, for the purpose of achieving both of functionality and sealability in a film having a functional layer, a laminated film on which a functional layer is formed in a discontinuous pattern shape has been suggested (for example, see JP2014-050988A).

### SUMMARY OF THE INVENTION

However, the method described in JP4450932B has a problem in that productivity is degraded since the position where the thickness of the sealant is reduced needs to be changed according to the size of the packaging material. Further, similarly in sealing processing of an end portion which is typically performed, there is a problem of degraded productivity since sealing is performed according to the size. In addition, since the hygroscopicity of a sealing site is suppressed, there is a problem in that the hygroscopic capacity of the entire hygroscopic material is decreased due to the presence of the sealing portion.

Further, in the laminated film described in JP2014-050988A, since the functional layers are positioned on the side which is in direct contact with the contents, there is a concern that the quality of the film may be changed depending on the contents. Further, a large amount of air is present between the functional layers. Therefore, in a case where the functional layers are hygroscopic layers, the functional layers do not have a function of suppressing moisture transport between the layers even in a case where the functional layers are separated from each other.

According to an embodiment of the present invention, there are provided a hygroscopic material which has a large hygroscopic capacity and is capable of maintaining excellent hygroscopicity for a long period of time even in a case where a sealing treatment is not performed on an end portion; a method of producing the same; and a packaging material.

Specific means for solving the above-described problems includes the following aspects.

<1> A hygroscopic material comprising: a support which contains a resin having moisture permeability and has roughness in at least one surface thereof; a hygroscopic layer which is disposed at least in recesses of one surface of the support; and a damp-proof layer which is disposed on the support and the hygroscopic layer disposed on one surface of the support.

<2> The hygroscopic material according to <1>, in which the thickness of the thickest portion of the hygroscopic layer is in a range of 5 μm to 100 μm.

<3> The hygroscopic material according to <1> or <2>, in which an area ratio of a region occupied by the hygroscopic layer to the entire region of the hygroscopic material is in a range of 50% or greater and less than 100% in a plan view.

<4> The hygroscopic material according to any one of <1> to <3>, in which the shape of a cross section of a projection included in the support orthogonal to a plane direction of the support is at least one selected from the group consisting of a triangle, a rectangle, a trapezoid, and a mountain shape having a top formed of a straight line.

<5> The hygroscopic material according to any one of <1> to <4>, in which a half-width of the cross section of a projection included in the support orthogonal to the plane direction of the support is in a range of 0.1 mm to 10 mm.

<6> The hygroscopic material according to any one of <1> to <5>, in which the thickness of the thinnest portion of the support is in a range of 10 μm to 200 μm.

<7> The hygroscopic material according to any one of <1> to <6>, in which the hygroscopic layer is a hygroscopic layer which has a porous structure containing amorphous silica particles, a water-soluble resin, and a hygroscopic agent.

<8> The hygroscopic material according to <7>, in which the water-soluble resin is polyvinyl alcohol having a degree of saponification of 99% or less and a degree of polymerization of 1500 or greater.

<9> The hygroscopic material according to any one of <1> to <8>, in which the hygroscopic layer contains calcium chloride as a hygroscopic agent.

<10> The hygroscopic material according to <1>, in which a degree of moisture permeability of the resin layer having moisture permeability is in a range of 1 g/m²·day to 50 g/m²·day.

<11> The hygroscopic material according to <7>, in which the water-soluble resin is polyvinyl alcohol having a degree of saponification of 70% to 99% and a degree of polymerization of 1500 to 4500.

<12> The hygroscopic material according to <7>, in which a porosity of the porous structure in the hygroscopic layer is in a range of 45% to 85%.

<13> A packaging material comprising: the hygroscopic material according to any one of <1> to <12>.

<14> A method of producing a hygroscopic material, comprising: forming recesses in at least one surface of a resin sheet having moisture permeability by performing heat embossing to prepare a support having roughness; forming a hygroscopic layer in at least recesses of one surface of the support; and forming a damp-proof layer on the one surface of the support, on which the hygroscopic layer is formed.

<15> The method of producing a hygroscopic material according to <14>, in which the shape of a cross section of a projection included in the support, which is orthogonal to a plane direction of the support, is at least one selected from the group consisting of a triangle, a rectangle, a trapezoid, and a mountain shape having a top formed of a straight line.

<1A> A hygroscopic material comprising: a support which contains a resin having moisture permeability and has a first surface and a second surface positioned on a side opposite to the first surface and in which the first surface includes at least one protrusion (projection) and at least one non-protrusion (recess) and the at least one non-protrusion includes at least one closed non-protrusion enclosed by at least one of the at least one protrusion; at least one portion (component) of a hygroscopic layer which is disposed in at least one of the at least one closed non-protrusion; and a damp-proof layer which is disposed on the at least one hygroscopic layer portion and a region other than the at least one hygroscopic layer portion on the first surface of the support.

<1B> The hygroscopic material according to <1A>, in which each of the at least one hygroscopic layer portion disposed on at least one closed non-protrusion fills a part or the entire space enclosed by the corresponding protrusion in the respectively corresponding closed non-protrusions.

<1C> The hygroscopic material according to <1A> or <1B>, in which the second surface includes at least one protrusion and at least one non-protrusion.

<1D> The hygroscopic material according to <1C>, in which at least one non-protrusion on the second surface includes at least one closed non-protrusion enclosed by at least one of the at least one protrusion on the second surface.

<1E> The hygroscopic material according to any one of <1A> to <1D>, in which the hygroscopic layer is not present on some protrusions of the first surface.

<1F> The hygroscopic material according to any one of <1A> to <1E>, in which at least one hygroscopic layer portion disposed on at least one closed non-protrusion of the first surface occupies preferably 50% or greater and less than 100%, more preferably 70% to 98%, and still more preferably 80% to 95% of the area of the first surface in a case where the at least one hygroscopic layer portion is seen in a direction orthogonal to the first surface.

Further, the “at least one portion of the hygroscopic layer” (which is disposed on at least one closed non-protrusion) indicates at least one individual (separated) portion (component) of the hygroscopic layer. That is, in a case where the hygroscopic layer includes two or more portions which are respectively disposed on closed non-protrusions, two or more of the closed non-protrusions are present and thus the hygroscopic layer disposed on the closed non-protrusions is separated to form two or more portions. Here, the hygroscopic layer is occasionally formed to have a small thickness even on the protrusions. In such a case, the hygroscopic layer portions disposed on the closed non-protrusions may be linked to one another through the hygroscopic layer region on the protrusions. Preferably, the hygroscopic layer is not formed on protrusions and is not continuously formed in this case. In a case where the hygroscopic layer includes two or more portions (components), these portions are separated from one another. In a case where a plurality of hygroscopic layers are mentioned in the description below, this indicates two or more portions of the hygroscopic layer with the same meaning as described above.

According to the present disclosure, it is possible to provide a hygroscopic material which has a large hygroscopic capacity and is capable of maintaining excellent hygroscopicity for a long period of time even in a case where a sealing treatment is not performed on an end portion; a method of producing the same; and a packaging material.

### BRIEF DESCRIPTION OF THE DRAWINGS

FIG. 1 is a cross-sectional view schematically illustrating an embodiment of a hygroscopic material of the present disclosure.

FIG. 2 is a cross-sectional view schematically illustrating a layer structure of a hygroscopic material of the related art.

FIG. 3 is a plan view illustrating production directions of a support on which a lattice pattern as an example of a pattern structure has been formed.

FIG. 4A is a cross-sectional view illustrating an example of the shape of roughness of the support by setting the broken line portion illustrated in FIG. 3 as the cut surface.

FIG. 4B is a cross-sectional view illustrating an example of the shape of roughness of the support by setting the broken line portion illustrated in FIG. 3 as the cut surface.

FIG. 4C is a cross-sectional view illustrating an example of the shape of roughness of the support by setting the broken line portion illustrated in FIG. 3 as the cut surface.

FIG. 4D is a cross-sectional view illustrating an example of the shape of roughness of the support by setting the broken line portion illustrated in FIG. 3 as the cut surface.

FIG. 5A is a cross-sectional view illustrating an example of the shape of a cross section orthogonal to a plane direction of the support.

FIG. 5B is a cross-sectional view of a projection of the support showing a measurement site with a half-width in the cross section of the projection of the support.

FIG. 5C is a cross-sectional view of a projection of the support showing a measurement site with a half-width in the cross section of the projection of the support.

FIG. 5D is a cross-sectional view of a projection of the support showing a measurement site with a half-width in the cross section of the projection of the support.

FIG. 6A is a plan view illustrating an example of a pattern structure with the roughness of the support.

FIG. 6B is a plan view illustrating an example of a pattern structure with the roughness of the support.

FIG. 6C is a plan view illustrating an example of a pattern structure with the roughness of the support.

FIG. 6D is a plan view illustrating an example of a pattern structure with the roughness of the support.

FIG. 6E is a plan view illustrating an example of a pattern structure with the roughness of the support.

FIG. 6F is a plan view illustrating an example of a pattern structure with the roughness of the support.

FIG. 7A is a plan view illustrating a measurement region for measuring an area occupied by a hygroscopic layer in the entire region of the hygroscopic material.

FIG. 7B is a cross-sectional view illustrating the measurement region.

FIGS. 8A to 8D are views schematically illustrating an example of a production process for a hygroscopic material of Example 1.

FIG. 9 is a cross-sectional view schematically illustrating the hygroscopic material of Example 1.

### DESCRIPTION OF THE PREFERRED EMBODIMENTS

Hereinafter, a hygroscopic material of the present disclosure, a method of producing the same, and a packaging material containing the hygroscopic material will be described in detail.

In the present specification, in a case where the amount of each component in a composition is mentioned and a plurality of materials corresponding to each component in the composition are present, the amount thereof indicates the total amount of the plurality of materials present in the composition unless otherwise noted.

The term “solid content” in the present specification indicates components excluding solvents and the “solid content” in the present specification also contains components in a liquid state such as low-molecular weight components other than solvents.

The numerical ranges shown using “to” in the present specification indicate ranges including the numerical values described before and after “to” as the lower limits and the upper limits, respectively.

<Hygroscopic Material>

The hygroscopic material of the present disclosure will be described with reference to the accompanying drawings.

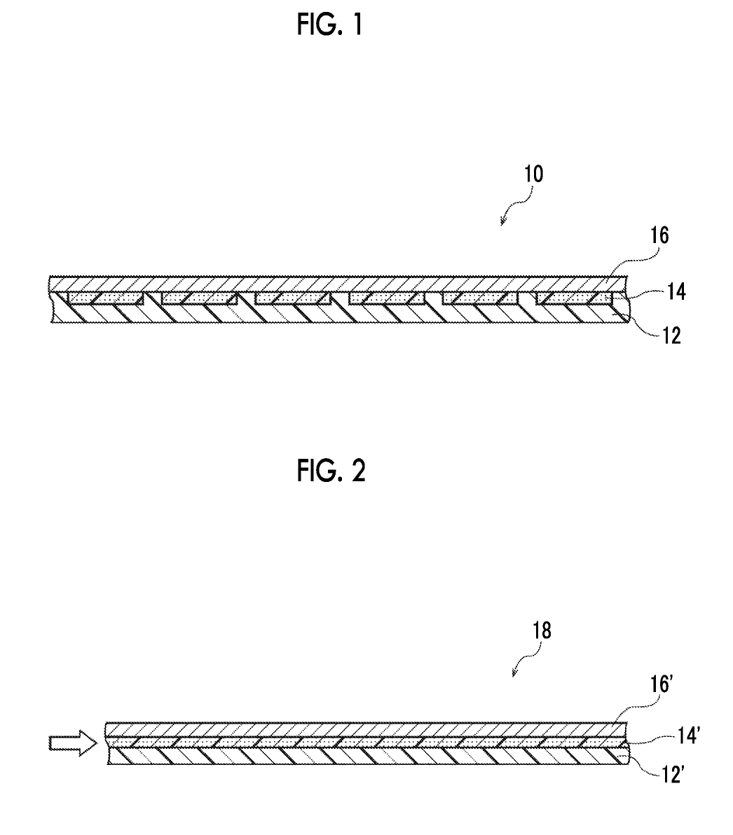

FIG. 1 is a cross-sectional view schematically illustrating a hygroscopic material 10 according to an embodiment of the present invention. The hygroscopic material 10 according to the embodiment illustrated in FIG. 1 includes a support (hereinafter, also simply referred to as a support) 12 which contains a resin having moisture permeability and has roughness in at least one surface thereof; a hygroscopic layer 14 which is disposed in at least recesses of the support 12; and a damp-proof layer 16 which is disposed on the support 12 and the hygroscopic layer 14 disposed on one surface of the support 12.

FIG. 2 is a cross-sectional view schematically illustrating a hygroscopic material 18 of the related art. A hygroscopic material of the related art illustrated in FIG. 2 includes a support 12′ containing a moisture-permeating resin; a hygroscopic layer 14′; and a damp-proof layer 16′, and the thickness of the hygroscopic layer 14′ is uniform. Accordingly, in a case where moisture infiltrates from an end portion of the hygroscopic material 18, that is, the arrow direction, there is a concern that the infiltrated moisture permeates to a deep portion of the hygroscopic layer 14′. In a case where the hygroscopic capacity of the hygroscopic layer 14′ is decreased due to the undesired moisture permeation from an end portion, for example, it becomes impossible to impart required hygroscopicity to inclusions sealed in a packaging material containing the hygroscopic material in some cases.

The mechanism of the hygroscopic material of the present disclosure is not clear, but can be assumed as follows.

In the hygroscopic material (for example, the hygroscopic material 10 in FIG. 1) of the present disclosure, moisture infiltrated from an end portion infiltrates into the hygroscopic layer (the hygroscopic layer portion; for example, the portion positioned in an end portion of the hygroscopic layer 14 in FIG. 1) positioned at the end portion. However, in the hygroscopic material of the present disclosure, the hygroscopic layer (hygroscopic layer portion) in an end portion and the hygroscopic layer (hygroscopic layer portion) adjacent to the hygroscopic layer in the end portion are partitioned by a projection of the support (for example, the support 12 in FIG. 1), infiltration of the moisture, which has been infiltrated into the end portion, into the adjacent hygroscopic layer (hygroscopic layer portion) is suppressed by a projection of the support. In the present disclosure, the support contains a resin having moisture permeability. However, moisture mobility as a liquid in a region where the support containing a resin having moisture permeability is present is extremely low, compared to the hygroscopic layer. Therefore, permeation of the moisture infiltrated from an end portion of the hygroscopic material into the hygroscopic layer (hygroscopic layer portion) present in a deeper portion of the hygroscopic material, which is separated from the hygroscopic layer (hygroscopic layer portion) positioned in an end portion, is effectively suppressed due to the presence of a projection of the support.

In the hygroscopic material 10 illustrated in FIG. 1, the shape of a cross section of a projection of the support 12 which is orthogonal to the plane direction of the support 12 is a rectangle (hereinafter, also simply referred to as a cross-sectional shape), but the cross-sectional shape of a projection of the support of the present disclosure is not limited to an aspect illustrated in FIG. 1. Any cross-sectional shape can be employed as long as the shape is suitable for physically separating hygroscopic layers (hygroscopic layer portions) adjacent to each other using projections of the support.

Since moisture permeation into the hygroscopic layer (hygroscopic layer portion) in a deeper portion of the hygroscopic material is suppressed, it is preferable that the region where the hygroscopic layer (hygroscopic layer portion) partitioned by projections of the support is present has a form in which the peripheral edges are enclosed by projections of the support and hygroscopic layers (hygroscopic layer portions) adjacent to each other are separated by projections of the support. In other words, the preferable form of the roughness of the support is a form in which at least one recess is enclosed by projections and it is preferable that hygroscopic layers adjacent to each other are separated by a projection.

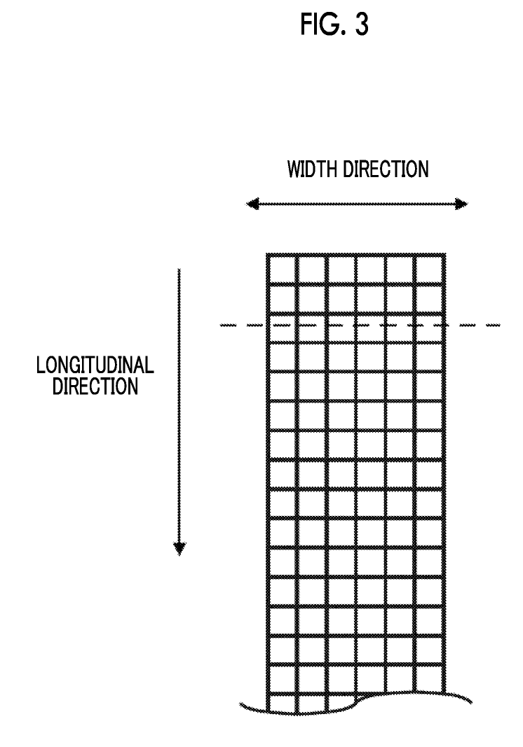

FIG. 3 is a plan view illustrating production directions of a support (for example, the support 12 in FIG. 1) having a lattice pattern formed by projections of the support. It is preferable that the lattice pattern on the support is continuously produced in the longitudinal direction. The solid line portions in FIG. 3 are regions where projections of the support are formed. The shape of the cross section of the support is confirmed using a cross section cut in a direction perpendicular to the longitudinal direction of the support. The broken line portion in FIG. 3 is set as the cut surface used for confirming the cross-sectional shape of the support.

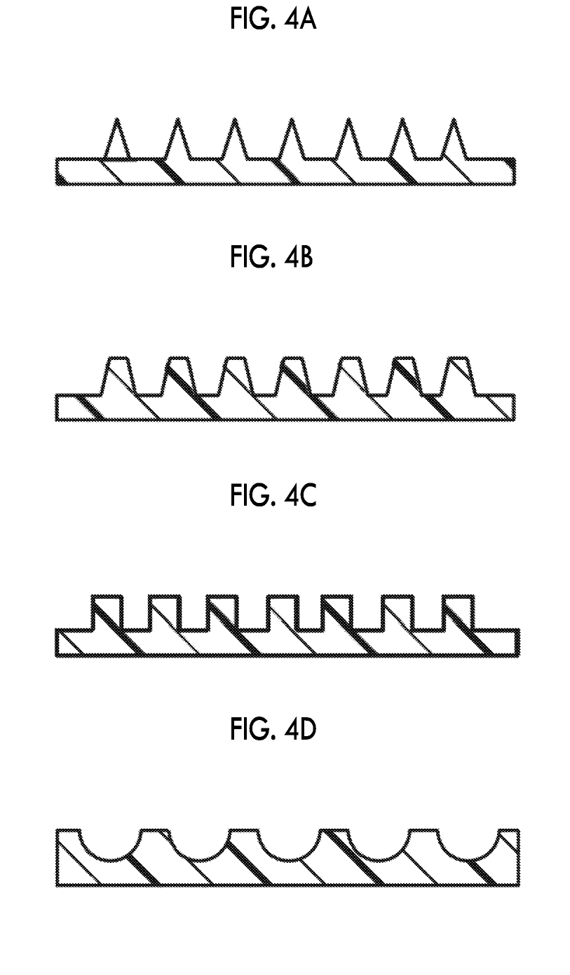

FIGS. 4A to 4D are examples of the cross-sectional shape of the support in a case where the broken line illustrated in FIG. 3 is set as the cut surface. In the present specification, the cross-sectional shape of a projection of the support is set as a cross-sectional shape of a portion protruding from the thinnest portion in the support.

FIG. 4A illustrates an example of the support in which the cross-sectional shape of a projection is a triangle; FIG. 4B illustrates an example of the support in which the cross-sectional shape of a projection is a trapezoid; FIG. 4C illustrates an example of the support in which the cross-sectional shape of a projection is a rectangle; and FIG. 4D illustrates an example of the support in which the cross-sectional shape of a projection is a mountain shape having a top portion formed of a straight line (that is, two sides which are non-parallel opposite sides of the trapezoid are formed in a shape in which the center of each side is curved in a recess shape so as to be depressed to the center of the trapezoid). In FIG. 4D, a recess of the support has a shape of a convex lens which is a shape close to a so-called hemispherical shape in which a tip is directed to the bottom surface of the support, that is, a side where the hygroscopic layer is not formed.

It is preferable that the cross-sectional shape of a projection of the support in the hygroscopic material of the present disclosure is at least one selected from the group consisting of a triangle as illustrated in FIG. 4A, a rectangle as illustrated in FIG. 4C, a trapezoid illustrated in FIG. 4B, and a mountain shape having a top formed of a straight line as illustrated in FIG. 4D.

From the viewpoint of the effect of suppressing moisture transport, it is preferable that the hygroscopic layer is unlikely to be formed on the top of a projection of the support. Specifically, a projection whose cross-sectional shape is a triangle, as an aspect in which the area of the top of a projection is extremely small, is preferable. Further, from the viewpoint that a sufficient volume of the support is provided between hygroscopic layers (hygroscopic layer portions) adjacent to each other, it is preferable that the cross-sectional shape of a projection is at least one selected from the group consisting of a rectangle, a trapezoid, and a mountain shape having a top formed of a straight line. In a case of a projection having at least one cross-sectional shape selected from the group consisting of a rectangle, a trapezoid, and a mountain shape having a top formed of a straight line, an aspect of performing a release treatment on the top of the projection is more preferable.

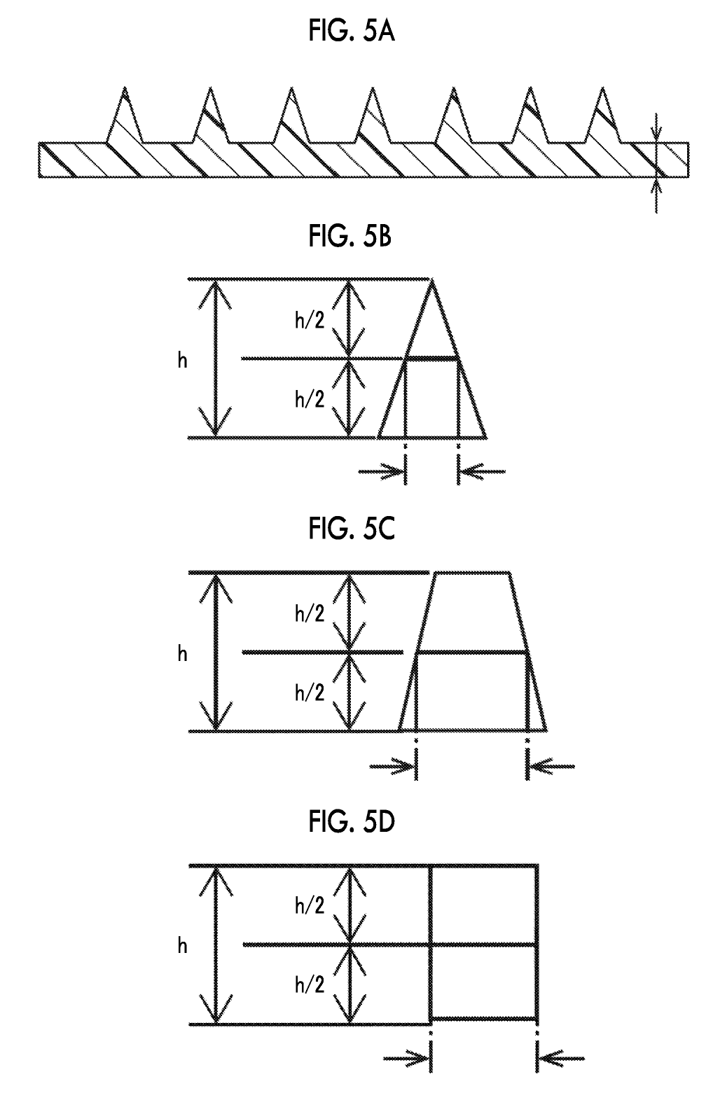

FIG. 5A is a cross-sectional view illustrating an example of the shape of a cross section orthogonal to the plane direction of the support and FIGS. 5B to 5D are respectively a cross-sectional view of a projection of the support showing a measurement site with a half-width in the projection of the support.

In the present disclosure, from the viewpoint that moisture permeation between hygroscopic layers (hygroscopic layer portions) adjacent to each other can be more effectively suppressed, it is preferable that a projection of the support has a sufficiently large thickness. Meanwhile, in a case where a projection of the support has a sufficiently large width, this results in a decrease of the area occupied by the hygroscopic layer with respect to the unit area of the hygroscopic material. From this viewpoint, more specifically, the half-width of the cross section of a projection included in the support is preferably in a range of 0.1 mm to 10 mm, more preferably in a range of 0.1 mm to 5 mm, still more preferably in a range of 0.1 mm to 1.5 mm, even still more preferably in a range of 0.1 mm to 1.0 mm, and particularly preferably in a range of 0.15 mm to 0.3 mm.

As described above, the cross-sectional shape of a projection of the support is a cross-sectional shape of a portion protruding from the thinnest portion in the support, and FIGS. 5B to 5D respectively illustrate a measurement site with a half-width in cases where the cross-sectional shape of a projection is a triangle (FIG. 5B), the cross-sectional shape of a projection is a trapezoid (FIG. 5C), and the cross-sectional shape of a projection is a rectangle (FIG. 5D). As illustrated in FIGS. 5B to 5D, in all cross-sectional shapes, the height of a projection of the support, that is, the width of a portion having a half height (indicated by h/2 in FIGS. 5B to 5D) of the height (indicated by h in FIGS. 5B to 5D) from the thinnest portion of the support to the top of a projection is set as a half-width of a projection of the support in the present specification.

FIG. 5A is a cross-sectional view illustrating an example of the support. The portion indicated by the arrows in FIG. 5A indicates a region for measuring the thickness of the thinnest portion of the support.

In the present disclosure, the thickness of the thinnest portion of the support is preferably in a range of 10 μm to 200 μm, more preferably in a range of 20 μm to 100 μm, and still more preferably in a range of 30 μm to 80 μm.

The thinnest portion of the support has a function of controlling the moisture permeability of the hygroscopic material. In a case where the thickness of the thinnest portion of the support is in the above-described range, the hygroscopic capacity is satisfactorily maintained and an excellent hygroscopic capacity is maintained for a long period of time.

The thickness of the thinnest portion of the support can be measured by, for example, cutting out a cross section of the support to prepare a slice sample and observing the cross section using a desk top microscope Miniscope TM-1000 (manufactured by Hitachi High-Technologies Corporation). In the present specification, the value obtained by measurement according to the above-described method is described.

The hygroscopic material of the present disclosure includes the hygroscopic layer in at least recesses of the support having the above-described roughness as illustrated in FIG. 1.

Further, in FIG. 1, the hygroscopic layer 14 is positioned only in the recesses of the support 12, but the present invention is not necessarily limited to the aspect illustrated in FIG. 1 and the hygroscopic layer may be present on the top of the projections of the support. From the viewpoint of the effects of the present disclosure, it is preferable that the thickness of the hygroscopic layer present on the top of the recesses of the support is small, for example, 5 μm or less and more preferable that the hygroscopic layer is not present on the top of the recesses of the support.

From the viewpoint that the hygroscopic material exhibits a sufficiently large hygroscopic capacity, the thickness of the thickest portion of the hygroscopic layer is preferably in a range of 5 μm to 100 μm, more preferably in a range of 20 μm to 80 μm, and still more preferably in a range of 30 μm to 70 μm.

Further, in a case where a recess of the support has a convex lens shape in which the tip is directed to the bottom surface of the support, the thickness of the thickest portion of the hygroscopic layer indicates the distance from the deepest region of the hygroscopic layer, that is, the top of a hemisphere to the height of the hygroscopic layer on a side where a projection of the support is formed.

Typically, as the thickness of the hygroscopic layer increases, the content of the hygroscopic agent contained in the hygroscopic layer can be increased and thus the hygroscopic capacity is also increased. In addition, although it depends on the applications of the hygroscopic material in a case where the thickness of the hygroscopic layer is increased, the handleability or the workability with respect to the packaging material or the like may be degraded. In a case where the maximum thickness of the hygroscopic layer is set to be in the above-described range, a hygroscopic material in which the balance of the hygroscopic capacity, the handleability, and the workability is excellent is obtained.

The maximum thickness of the hygroscopic layer can be measured by, for example, cutting out a cross section of the hygroscopic material, in a region where the hygroscopic layer is formed, in a direction orthogonal to the surface of the support to prepare a slice sample and observing the cross section using a desk top microscope Miniscope TM-1000 (manufactured by Hitachi High-Technologies Corporation). In the present specification, the value obtained by measurement according to the above-described method is described.

According to the hygroscopic material of the present disclosure, even in a case where a long hygroscopic material is continuously produced, cut to have an arbitrary shape and an arbitrary size, and then used, permeation of moisture from the cut end portion of the hygroscopic layer is suppressed at the peripheral edge of the hygroscopic material so that the moisture is unlikely to permeate into even the deep portion, that is, the central portion of the hygroscopic material. Therefore, a hygroscopic material which is capable of maintaining a desired hygroscopic capacity for a long period of time can be obtained without performing a special sealing treatment on the end portion of the hygroscopic material.

In other words, the hygroscopic material of the present disclosure has advantages that it is not necessary to perform a sealing treatment on an end portion of the hygroscopic material after being cut into an arbitrary shape or to produce the hygroscopic material according to the size of a desired package from the beginning and the production efficiency is excellent.

Although not illustrated in FIG. 1, the hygroscopic material of the present disclosure may include layers other than the support having roughness, the hygroscopic layer positioned in recesses of the support, and the damp-proof layer as necessary. Examples of the other layers include an adhesive layer.

The hygroscopic capacity increases as the area of the region occupied by the hygroscopic layer in the entire region of the hygroscopic material in a case where the region is seen in a direction orthogonal to the surface of the support with roughness in a plan view increases. However, in a case where the area is extremely large, the width of a projection of the support which is present between hygroscopic layers (hygroscopic layer portions) is relatively decreased so that the effect of suppressing moisture permeation is reduced in some cases. Therefore, in consideration of the balance therebetween, it is preferable that the region occupied by the hygroscopic layer with respect to the entire region of the hygroscopic material is 50% or greater and less than 100% in terms of area ratio in a plan view. Hereinafter, in the present specification, the “area” of the hygroscopic layer or the like indicates the area in a plan view.

From the viewpoint of obtaining a sufficiently large hygroscopic capacity, the area ratio of the hygroscopic layer to the entire region of the hygroscopic material is preferably 50% or greater, more preferably 70% or greater, and still more preferably 80% or greater in a plan view.

The area ratio of the area of the hygroscopic layer to the entire region of the hygroscopic material is preferably 50% or greater and less than 100%, more preferably in a range of 70% to 98%, and still more preferably 80% to 95%.

In a case where the area of the hygroscopic layer region with respect to the entire region of the hygroscopic material is 50% or greater, a sufficiently large hygroscopic capacity for the hygroscopic material 10 can be achieved. In a case where the area thereof is less than 100%, the effect of suppressing moisture transport between hygroscopic layers (hygroscopic layer portions) adjacent to each other can be obtained.

For example, in a case where non-stretched polypropylene (CPP) is used as a moisture-permeating resin, moisture absorption from an end surface can be sufficiently suppressed based on the calculation from the degree of moisture permeability of CPP in a case where a projection has a half-width of 150 μm.

The formation pattern of projections of the present disclosure is not limited to a repeating pattern. For example, in consideration of an aspect of a projection shape that has only one lattice in a width direction, the area ratio of the region occupied by the hygroscopic layer to the entire region of the hygroscopic material is 99.9% in a case where a lattice pattern having a half-width of 150 μm and a size of 680 mm×680 mm is provided for a support having a width of 700 mm. Even in a case where one or two large area patterns are provided in the width direction of the hygroscopic material, moisture permeation can be sufficiently suppressed and the effects of the present disclosure are exhibited in a case where a projection of the support present in an end portion has a half-width of 0.1 mm, that is, 100 μm or greater as described above.

The pattern structure formed by peripheral edges of the hygroscopic layer in the hygroscopic material of the present disclosure being partitioned by projections of the support is not particularly limited as long as the hygroscopic layer region has a pattern structure formed such that projections of the support are separated from one another in a region where the projections of the support are present. Any pattern having a so-called sea-island pattern in which the region of the hygroscopic layer corresponds to an island and the region where projections of the support are formed corresponds to sea can be used.

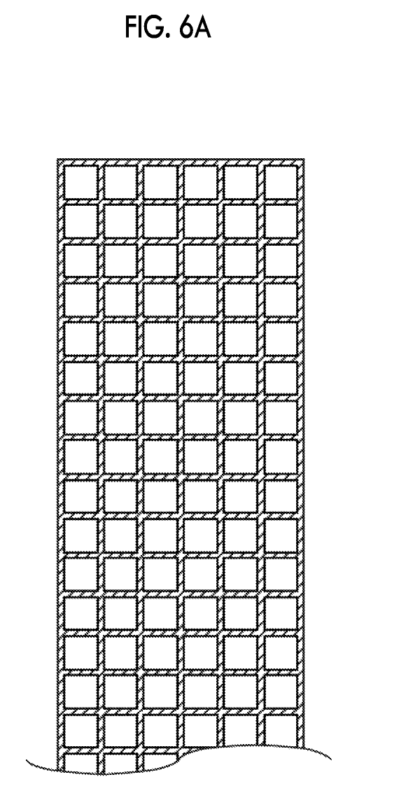

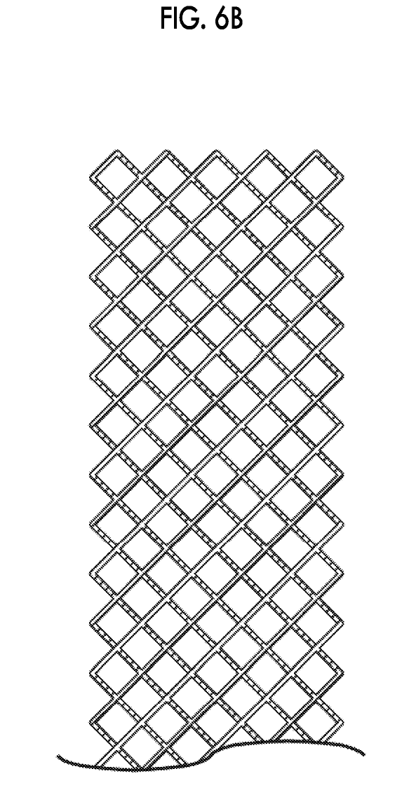

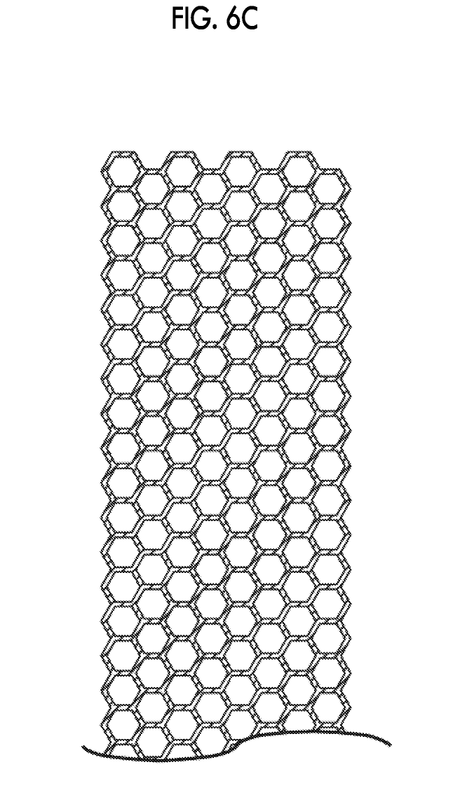

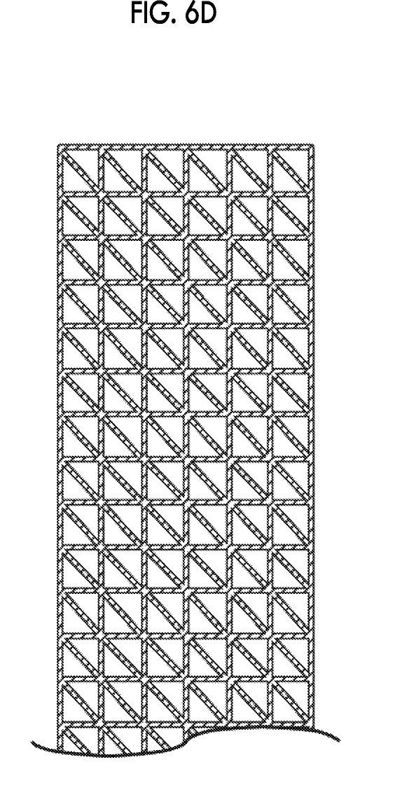

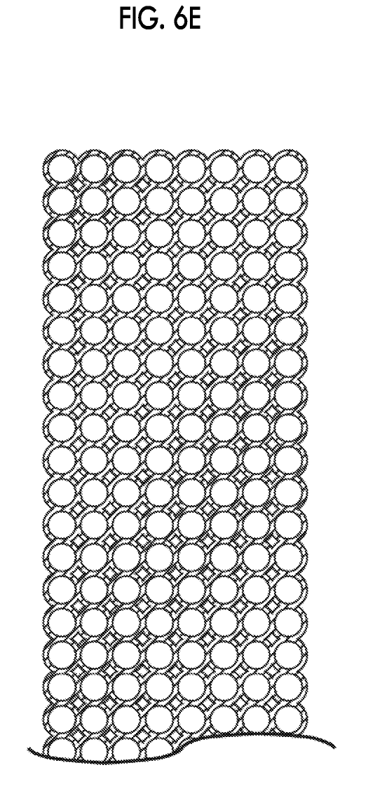

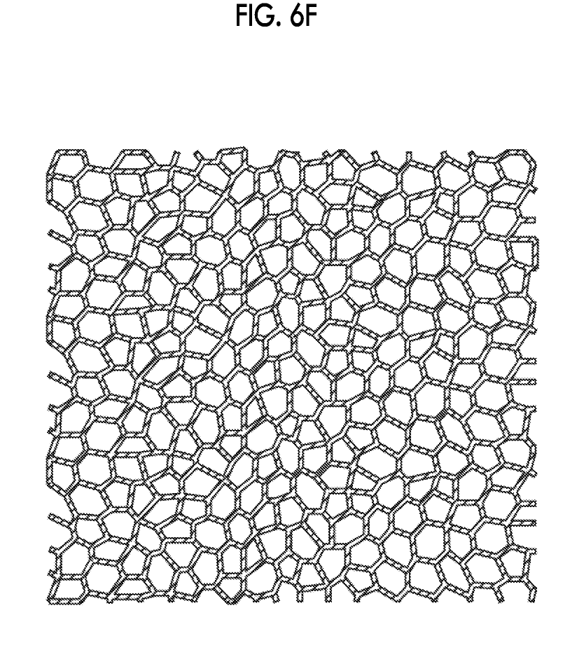

As an example of the pattern structure in a plan view, pattern structures illustrated in FIGS. 6A to 6F are exemplified. In the pattern structures as illustrated in FIGS. 6A to 6F, regions shown by oblique lines indicate regions where projections of the support are present and white outlined regions indicate regions where recesses of the support in which hygroscopic layers (hygroscopic layer portions) are formed are present.

FIGS. 6A and 6B respectively illustrate a lattice pattern in which hygroscopic layers (hygroscopic layer portions) have a square shape in a plan view. FIG. 6C illustrates a honeycomb pattern in which hygroscopic layers (hygroscopic layer portions) have a hexagonal shape, FIG. 6D illustrates a pattern in which hygroscopic layers (hygroscopic layer portions) have a triangular shape, and FIG. 6E illustrates a pattern in which hygroscopic layers (hygroscopic layer portions) have a circular shape. That is, in the pattern in a plan view illustrated in FIG. 6E, a recess where the hygroscopic layer is present may have a columnar shape in which the cross-sectional area in the depth direction thereof is uniform or a plano-convex lens shape in which the cross-sectional area thereof is decreased toward the bottom portion of a recess so that the bottom portion of a recess used as the top.

The pattern structures illustrated in FIGS. 6A to 6E are pattern structures respectively having a regularly repeating unit.

As described above, in a case of the sea-island structure, that is, in a case where the hygroscopic layer regions are separated from one another due to the projection regions of the support, the pattern structure of the hygroscopic layer (hygroscopic layer portion) may be an irregular pattern structure which does not have a repeating pattern such as a stone-wall structure illustrated in FIG. 6F.

Among examples of such a pattern, from the viewpoint that the production is easy and a uniform hygroscopic capacity can be easily achieved as a whole or in a case where the material is cut in a desired size, a pattern structure having a regularly repeating unit is preferable. In other words, it is preferable that the hygroscopic layer portions disposed in recesses (closed non-protrusions) enclosed by projections in the present disclosure are disposed in a regularly repeating pattern shape as described above. The disposition of the hygroscopic layer portions disposed in the closed non-protrusions is referred to as a specific pattern including a case where the number of hygroscopic layer portions in the hygroscopic material is 1. The total number of the hygroscopic layer portions disposed in the closed non-protrusions in the hygroscopic material may be 1 or greater and preferably 2 or greater. For example, the total number thereof may be 5 or greater, 10 or greater, 50 or greater, or 100 or greater. In addition, the number of the hygroscopic layer portions disposed in the closed non-protrusions in a specific pattern is preferably 0.1 to 500 pcs/cm² and more preferably in a range of 0.2 to 300 pcs/cm².

The above-described pattern structure having a repeating unit has an advantage that the area ratio of the projection regions of the support to the entire region of the hygroscopic material can be easily adjusted.

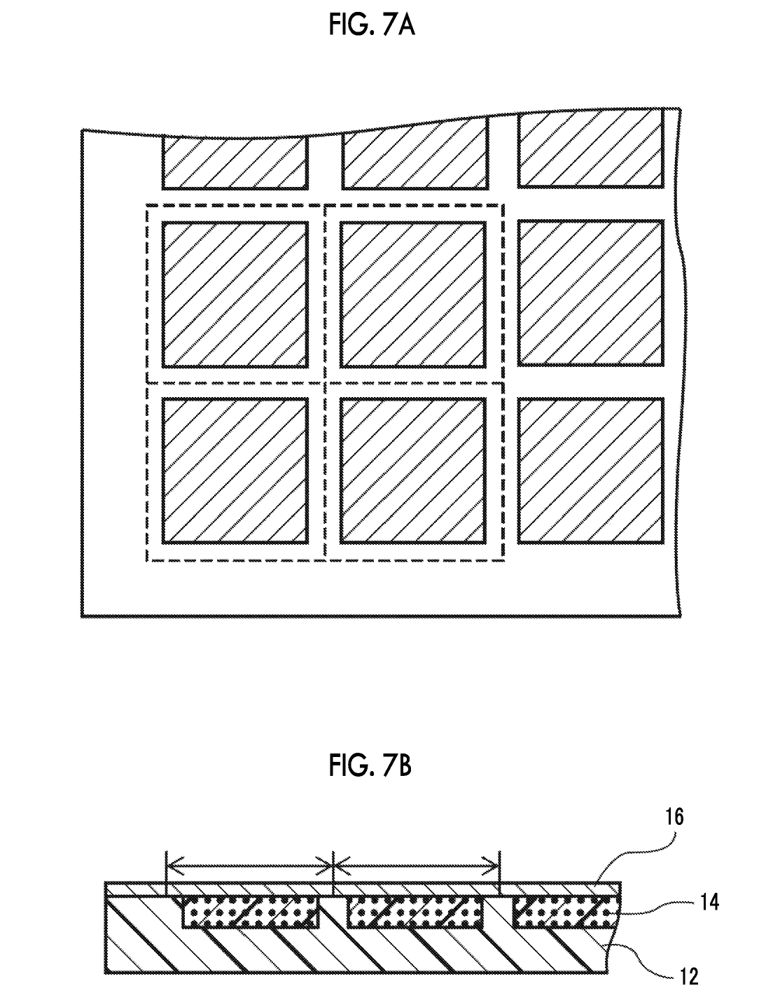

Further, in a case the pattern having a regularly repeating unit, for example, a method of estimating the total area ratio from the area of the pattern having one regularly repeating unit can be employed in a case where the region occupied by the hygroscopic layer to the entire region of the hygroscopic material is calculated as illustrated in the plan view of FIG. 7A and the cross-sectional view of FIG. 7B.

In other words, the ratio of the area occupied by the hygroscopic layer to the entire region of the hygroscopic material can be estimated by assuming that the area of the repeating units partitioned by the broken lines of FIG. 7A is the area of the entire region of the hygroscopic material, assuming that the area of the regions partitioned by the solid lines is the area of the hygroscopic layer regions, and measuring the area of a repeating unit partitioned by the broken lines and the area of a region partitioned by the solid lines in one repeating unit to calculate the area ratio therebetween.

In FIGS. 7A and 7B, a region where only the damp-proof layer 16 is formed on the support 12 and the hygroscopic layer 14 is not formed is present in an end portion of the hygroscopic material in the longitudinal direction. However, since this region is a region on which an emboss pattern is not formed during the production and which is cut and removed in productization, the ratio of the area occupied by the hygroscopic layer 14 in the entire region of the hygroscopic material can be estimated with high precision by measuring the area ratio of the region obtained by removing an end portion of the hygroscopic material in the longitudinal direction as illustrated in FIG. 7A.

Next, each layer included in the hygroscopic material (for example, the hygroscopic material 10 in FIG. 1) will be described below.

Hygroscopic Layer

The hygroscopic layer included in the hygroscopic material of the present disclosure contains a hygroscopic agent and is not particularly limited as long as the layer is capable of exhibiting required hygroscopicity.

Examples of the hygroscopic layer include a hygroscopic layer containing a known hygroscopic agent such as silica gel, alumina gel, a molecular sieve, zeolite, or calcium chloride and a resin serving as a dispersion medium; a hygroscopic layer which is a microporous film carrying a hygroscopic agent as described in JP1991-114509A (JP-H03-114509A); and a hygroscopic layer having a porous structure which contains amorphous silica, a water-soluble resin, and a hygroscopic agent.

Among these, from the viewpoints easily controlling the film thickness of the hygroscopic layer and having an excellent hygroscopic capacity, as the hygroscopic layer in the hygroscopic material of the present disclosure, a hygroscopic layer 14 having a porous structure which contains amorphous silica particles, a water-soluble resin, and a hygroscopic agent is preferable. In a case where the hygroscopic layer has a three-dimensional porous structure and voids therein, moisture can be held in a void of the hygroscopic layer in addition to the hygroscopic capacity of the hygroscopic agent so that the hygroscopic capacity of the entire hygroscopic layer becomes excellent.

Hereinafter, as a preferable hygroscopic layer of the present disclosure, the hygroscopic layer having a porous structure will be described in detail.

The preferable hygroscopic layer of the present disclosure has a porous structure containing amorphous silica, a water-soluble resin, and a hygroscopic agent and may further contain a cross-linking agent. Further, the hygroscopic layer may contain other components such as a dispersant or a surfactant as necessary. From the viewpoint of the effects of the present disclosure, it is preferable that silica having an average secondary particle diameter of 10 μm or less is used as the amorphous silica.

The hygroscopic speed in the hygroscopic layer can be controlled by changing the thickness of the hygroscopic layer or the type of the hygroscopic agent. Further, the hygroscopic speed in the hygroscopic layer can be controlled by changing the thickness of the adhesive layer or the type of the adhesive used for adhesion between layers during lamination.

Amorphous Silica

According to the preferred aspect of the present disclosure, the hygroscopic layer may contain at least one kind of amorphous silica.

The amorphous silica indicates a porous amorphous fine particle in which a three-dimensional structure of SiO₂ is formed and is typically and largely classified into a wet method particle and a dry method (vapor phase method) particle according to the production method thereof. Examples of the amorphous silica include synthetic amorphous silica such as vapor phase method silica obtained using a dry method and wet silica obtained using a wet method.

Vapor Phase Method Silica

The vapor phase method silica is silica (silica fine particles) synthesized by vaporizing a silicon chloride and causing a vapor phase reaction in a hydrogen flame at a high temperature.

Since the vapor phase method silica has a low refractive index, the transparency can be imparted to the hygroscopic layer by performing dispersion up to an appropriate fine particle diameter. From the viewpoint that the contents in packaging can be visually observed and an indicator function or the like can be imparted, it is preferable that the hygroscopic layer is transparent.

Further, the vapor phase method silica and hydrous silica are different from each other in density of a silanol group on the surface and presence of pores and these two exhibit different properties, but the vapor phase method silica is suitable for forming a three-dimensional structure having a high porosity. The reason for this is not clear, but it is assumed that the density of the silanol group on the surface of fine particles is in a range of 5 pcs/nm² to 8 pcs/nm², which is high, so that silica particles tend to be densely aggregated in a case of the hydrous silica; and the density of the silanol group on the surface of fine particles is in a range of 2 pcs/nm² to 3 pcs/nm², which is low, so that silica particles tend to be sparsely flocculated and thus a porous structure with a high porosity is obtained in a case of the vapor phase method silica.

As the vapor phase method silica contained in the hygroscopic layer, vapor phase method silica in which the density of the silanol group on the surface is in a range of 2 pcs/nm² to 3 pcs/nm² is preferable. The average primary particle diameter of the vapor phase method silica contained in the hygroscopic layer is not particularly limited, but is preferably 20 nm or less and more preferably 10 nm or less from the viewpoint of the transparency of the hygroscopic layer.

From the viewpoint of the transparency of the hygroscopic layer, the average secondary particle diameter of the vapor phase method silica contained in the hygroscopic layer is preferably 10 μm or less, more preferably 50 nm or less, and still more preferably 25 nm or less. Further, from the viewpoint of the transparency of the hygroscopic layer, it is preferable that the secondary particle size distribution is uniform, and the standard deviation is preferably 10 nm or less, more preferably 8 nm or less, and particularly preferably 5 nm or less.

In a case where the average secondary particle diameter of the vapor phase method silica is 10 μm or less, the transparency and the visibility of the hygroscopic material become excellent.

The average primary particle diameter in the present specification indicates an average diameter of primary particles obtained by observing 100 fine particles using a transmission electron microscope, acquiring the projected area of each particle to obtain the diameter assuming a circle having the same area as the projected area, and simply averaging the diameters of 100 fine particles.

Further, the average secondary particle diameter in the present specification indicates an average diameter of secondary particles obtained by observing 100 aggregated particles using a scanning electron microscope, acquiring the projected area of each particle to obtain the diameter assuming a circle having the same area as the projected area, and simply averaging the diameters of 100 aggregated particles.

Commercially available products may be used as the vapor phase method silica. Examples of the commercially available products of the vapor phase method silica which can be used in the present disclosure include AEROSIL (trade name, manufactured by NIPPON AEROSIL CO., LTD.), REOLOSIL (trade name, manufactured by Tokuyama Corporation), WAKER HDK (trade name, manufactured by Asahi Kasei Corp.), and CAB-O-SIL (trade name, manufactured by Cabot Corporation). Among these, AEROSIL 300 SF75 (trade name, manufactured by NIPPON AEROSIL CO., LTD.) is preferable.

Wet Silica

Wet silica is hydrous silica obtained by generating active silica through acid decomposition of a silicate, properly polymerizing the obtained active silica, and aggregating and precipitating the active silica.

The wet silica is classified into precipitation method silica, gel method silica, and sol method silica according to the production method thereof. The precipitation method silica is obtained by reacting sodium silicate with sulfuric acid under alkaline conditions to produce silica particles, aggregating and precipitating grown silica particles, and performing processes of filtration, washing with water, drying, pulverization, and classification. Examples of the precipitation method silica include NIPSIL (trade name, manufactured by Tosoh Silica Corporation) and TOKUSIL (trade name, manufactured by Tokuyama Corporation). Further, the gel method silica is obtained by reacting sodium silicate with sulfuric acid under acidic conditions, and specific examples thereof include NIPGEL (trade name, manufactured by Tosoh Silica Corporation) and SYLOID and SYLOJET (both trade names, manufactured by Grace Japan K.K.).

The specific surface area of the amorphous silica contained in the hygroscopic layer according to a BET method is preferably 200 m²/g or greater and more preferably 250 m²/g or greater. In a case where the specific surface area of the vapor phase method silica is 200 m²/g or greater, excellent transparency of the hygroscopic layer can be maintained.

The BET method in the present specification is one of the surface area measurement methods for powder using a vapor phase adsorption method and is also a method of acquiring the total surface area of 1 g of a sample from an adsorption isotherm, that is, the specific surface area. Typically, nitrogen gas is frequently used as adsorption gas, and a method of measuring the adsorption amount based on a change in pressure or volume of the adsorbed gas is most frequently used. The Brunauer-Emmett-Teller Equation which is referred to as the BET Equation is the most prominent equation for representing the isotherm of multimolcular adsorption and has been widely used for determination of the surface area. The surface area is obtained by acquiring the adsorption amount based on the BET equation and multiplying the adsorption amount by the area occupied by one adsorbed molecule on the surface.

From the viewpoints of the hygroscopic capacity and the transparency of the hygroscopic layer, the content of the amorphous silica in the hygroscopic layer is preferably in a range of 20% by mass to 80% by mass and more preferably in a range of 30% by mass to 70% by mass with respect to the total solid content of the hygroscopic layer.

As a dispersion method for realizing the secondary particle diameter of the vapor phase method silica in the hygroscopic layer, it is preferable that a dispersant is added thereto and, for example, a cationic polymer can be used. Examples of the cationic polymer include mordants described in paragraphs [0138] to [0148] of JP2006-321176A.

Further, as the dispersion method for realizing the secondary particle diameter of the vapor phase method silica, for example, various known dispersing machines of the related art such as a high-speed rotation dispersing machine, a medium stirring type dispersing machine (such as a ball mill, a sand mill, or a beads mill), an ultrasonic dispersing machine, a colloid mill dispersing machine, or a high-pressure dispersing machine can be used. Among these, a beads mill dispersing machine or a liquid-liquid collision type dispersing machine is preferable and a liquid-liquid collision type dispersing machine is more preferable. Examples of the liquid-liquid collision type dispersing machine include ULTIMIZER (trade name, manufactured by SUGINO MACHINE LIMITED CO., LTD.).

Water-Soluble Resin

The preferable hygroscopic layer of the present disclosure may contain at least one water-soluble resin.

In a case where the hygroscopic layer contains a water-soluble resin, the vapor phase method silica is contained in a state of being more suitably dispersed therein and the strength of the hygroscopic layer is further improved.

The water-soluble resin which can be used in the present disclosure indicates a resin to be finally dissolved in an amount of 0.05 g or greater and preferably 0.1 g or greater in 100 g of water at 20° C. through a heating step or a cooling step.

Examples of the water-soluble resin include a polyvinyl alcohol-based resin which is a resin containing a hydroxy group as a hydrophilic structural unit [such as polyvinyl alcohol (PVA), acetoacetyl-modified polyvinyl alcohol, cation-modified polyvinyl alcohol, anion-modified polyvinyl alcohol, silanol-modified polyvinyl alcohol, or polyvinyl acetal], a cellulose-based resin [such as methyl cellulose (MC), ethyl cellulose (EC), hydroxyethyl cellulose (HEC), carboxymethyl cellulose (CMC), hydroxypropyl cellulose (HPC), hydroxyethyl methyl cellulose, or hydroxypropyl methyl cellulose], chitins, chitosans, starch, a resin having an ether bond [such as polypropylene oxide (PPO), polyethylene glycol (PEG), or polyvinyl ether (PVE)], and a resin containing a carbamoyl group [such as polyacrylamide (PAAM), polyvinylpyrrolidone (PVP), or polyacrylic acid hydrazide]. Further, other examples of the water-soluble resin include polyacrylate containing a carboxyl group as a dissociable group, a maleic acid resin, alginate, and gelatins.

Among the above-described water-soluble resins, from the viewpoint of the film hardness of the hygroscopic layer, a polyvinyl alcohol-based resin is preferable and polyvinyl alcohol is particularly preferable.

The degree of polymerization of the water-soluble resin is preferably 1500 or greater, more preferably 2000 or greater, and still more preferably 3300 or greater. Further, the degree of polymerization thereof is preferably 4500 or less.

From the viewpoint of the film hardness of the hygroscopic layer, the water-soluble resin is a polyvinyl alcohol-based resin, and the degree of polymerization of the polyvinyl alcohol-based resin is preferably 1500 or greater, more preferably 2000 or greater, and still more preferably 2400 or greater. In addition, the degree of polymerization of the polyvinyl alcohol-based resin is more preferably 4500 or less.

The degree of saponification of the water-soluble resin is preferably 99% or less, more preferably 95% or less, and still more preferably 90% or less. Further, the degree of saponification thereof is preferably 70% or greater, more preferably 78% or greater, and still more preferably 85% or greater.

From the viewpoint of the transparency of the hygroscopic layer, the water-soluble resin is a polyvinyl alcohol-based resin, and the degree of saponification of the polyvinyl alcohol-based resin is preferably in a range of 70% to 99%, more preferably in a range of 78% to 99%, and still more preferably in a range of 85% to 99%.

In a case where the degree of saponification of the water-soluble resin is 70% or greater, the resin is practically suitable for maintaining water solubility.

It is preferable that the water-soluble resin used in the hygroscopic layer of the present disclosure is polyvinyl alcohol having a degree of saponification of 99% or less and a degree of polymerization of 3300 or greater.

Further, in a case where polyvinyl alcohol is used as the water-soluble resin and boric acid is used as a cross-linking agent, it is more preferable that the degree of saponification of the polyvinyl alcohol is in a range of 78% to 99% and the degree of polymerization thereof is in a range of 1500 to 4500 and more preferably in a range of 2400 to 3500.

Moreover, in a case where polyvinyl alcohol is used as the water-soluble resin and a cross-linking agent is not used, from the viewpoint that the same porous structure as that in the case of using a cross-linking agent can be formed, it is preferable that the degree of saponification of the polyvinyl alcohol is low and the degree of polymerization thereof is high. Specifically, the degree of saponification of the polyvinyl alcohol is preferably in a range of 78% to 99% and the degree of polymerization of the polyvinyl alcohol is preferably in a range of 2400 to 4500.

Preferred examples of the water-soluble resin also include derivatives of the resins described above as the specific examples.

The water-soluble resin contained in the hygroscopic layer may be used alone or in combination of two or more kinds thereof.

From the viewpoint of preventing a decrease in film hardness and cracking at the time of drying due to the extremely small content of the water-soluble resin and the viewpoint of preventing a decrease in hygroscopicity caused by voids being easily closed by the resin so that the porosity is decreased due to the extremely large content of the water-soluble resin, the content (the total content in a case where two or more kinds of resins are used in combination) of the water-soluble resin in the hygroscopic layer is preferably in a range of 4.0% by mass to 16.0% by mass and more preferably in a range of 6.0% by mass to 14.0% by mass with respect to the total solid content of the hygroscopic layer.

In a case where polyvinyl alcohol is used as the water-soluble resin and boric acid is used as a cross-linking agent of the polyvinyl alcohol, the content of the polyvinyl alcohol in the hygroscopic layer is preferably in a range of 10% by mass to 60% by mass and more preferably in a range of 15% by mass to 30% by mass with respect to the total mass of the amorphous silica. In a case where polyvinyl alcohol is used as the water-soluble resin and a cross-linking agent of the polyvinyl alcohol is not used, the content of the polyvinyl alcohol in the hygroscopic layer is preferably in a range of 25% by mass to 60% by mass with respect to the total mass of the amorphous silica.

The water-soluble resin contains a hydroxyl group in the structural unit thereof, and the hydroxyl group and the silanol group on the surface of the vapor phase method silica form a hydrogen bond so that a three-dimensional network structure using the secondary particles of the vapor phase method silica as a chain unit is easily formed. It is considered that a hygroscopic layer having a porous structure with a high porosity can be formed due to the formation of such a three-dimensional network structure. It is assumed that the obtained hygroscopic layer having porous structure functions as a layer that holds absorbed moisture.

Further, a preferred aspect of the porosity of the hygroscopic layer and a method of measuring the porosity will be described below.

Cross-Linking Agent

The hygroscopic layer may contain at least one cross-linking agent which is capable of forming a cross-linked structure in the water-soluble resin. It is preferable that the hygroscopic layer contains a cross-linking agent because a cross-linked structure is formed in the layer containing a water-soluble resin, for example, polyvinyl alcohol using a cross-linking reaction and a hygroscopic layer having a porous structure which has been cured at a higher level is formed due to the cross-linked structure.

As the cross-linking agent, a suitable one may be appropriately selected by considering the relationship between the cross-linking agent and the water-soluble resin contained in the hygroscopic layer. From the viewpoint of a rapid cross-linking reaction, a boron compound is preferable as the cross-linking agent. Examples of the boron compound which can be used as the cross-linking agent include borax, boric acid, borate (such as orthoborate, InBO₃, ScBO₃, YBO₃, LaBO₃, Mg₃(BO₃)₂, or Co₃(BO₃)₂), diborate (such as Mg₂B₂O₅ or Co₂B₂O₅), metaborate (such as LiBO₂, Ca(BO₂)₂, NaBO₂, or KBO₂), tetraborate (such as Na₂B₄O₇.10H₂O), pentaborate (such as KB₅O₈.4H₂O, CsB₅O₅), and hexaborate (such as Ca₂B₆O₁₁.7H₂O).

Among the examples of the boron compound, from the viewpoint of more rapidly promoting the cross-linking reaction, borax, boric acid, or borate is preferable; boric acid is particularly preferable; and a combination with a polyvinyl alcohol-based resin that is suitably used as a water-soluble resin is most preferable.

Further, in a case of forming the hygroscopic layer having a pattern structure as described in the present disclosure, the hygroscopic layer may not necessarily contain a cross-linking agent. Further, from the viewpoint of further improving the environmental suitability, a configuration in which the hygroscopic layer does not contain a cross-linking agent such as boric acid may be employed.

In a case of preparing the hygroscopic layer containing the cross-linked structure, the content of the boron compound serving as a cross-linking agent is preferably in a range of 0.15% by mass to 5.80% by mass and more preferably in a range of 0.75% by mass to 3.50% by mass with respect to 4.0% by mass to 16.0% by mass of polyvinyl alcohol. In a case where the content of the boron compound is in the above-described range, the polyvinyl alcohol is effectively cross-linked and occurrence of undesired cracks in the hygroscopic layer is suppressed.

In a case where gelatin is used as the water-soluble resin or the like, the following compounds other than the boron compound can be used as a cross-linking agent. The cross-linking agents other than the boron compound serving as cross-linking agents suitable for polyvinyl alcohol are also referred to as “other cross-linking agents” described below.

Examples of other cross-linking agents include an aldehyde-based compound such as formaldehyde, glyoxal, or glutaraldehyde; a ketone-based compound such as diacetyl or cyclopentanediol; an active halogen compound such as bis(2-chloroethylurea)-2-hydroxy-4,6-dichloro-1,3,5-triazine or 2,4-dichloro-6-S-triazine sodium salt; an active vinyl compound such as divinylsulfonic acid, 1,3-vinyl sulfonyl-2-propanol, N,N′-ethylenebis(vinylsulfonylacetamide), or 1,3,5-triacryloyl-hexahydro-S-triazine; a N-methylol compound such as dimethylol urea or methylol dimethyl hydantoin; a melamine resin (such as methylol melamine or alkylated methylol melamine); an epoxy resin; an isocyanate-based compound such as 1,6-hexamethylene diisocyanate; an aziridine-based compound described in the specification of U.S. Pat. No. 3,017,280A and the specification of U.S. Pat. No. 2,983,611A; a carboximide-based compound described in the specification of U.S. Pat. No. 3,100,704A; an epoxy-based compound such as glycerol triglycidyl ether; an ethyleneimino-based compound such as 1,6-hexamethylene-N,N′-bisethylene urea; a halogenated carboxyaldehyde-based compound such as mucochloric acid or mucophenoxychloric acid; a dioxane-based compound such as 2,3-dihydroxy dioxane; a metal-containing compound such as titanium lactate, aluminum sulfate, chrome alum, potash alum, zirconyl acetate, or chromium acetate; a polyamine compound such as tetraethylene pentamine; a hydrazide compound such as adipic acid dihydrazide; and a low-molecular weight compound or a polymer containing two or more oxazoline groups.

Other cross-linking agents may be appropriately selected according to the type of the water-soluble resin used in the hygroscopic layer.

Other cross-linking agents contained in the hygroscopic layer may be used alone or in combination of two or more kinds thereof.

Hygroscopic Agent

The preferable hygroscopic layer of the present disclosure may contain at least one hygroscopic agent.

Examples of the hygroscopic agent include silica gel, alumina gel, zeolite, a water-absorbing polymer, and a hygroscopic salt. Among these, from the viewpoint of the hygroscopic speed, a hygroscopic salt is preferable.

Specific examples of the hygroscopic salt include a halogenated metal salt such as lithium chloride, calcium chloride, magnesium chloride, or aluminum chloride; a metal sulfate such as sodium sulfate, calcium sulfate, magnesium sulfate, or zinc sulfate; a metal acetate such as potassium acetate; an amine salt such as dimethylamine hydrochloride; a phosphoric acid compound such as orthophosphoric acid; a guanidine salt such as guanidine hydrochloride, guanidine phosphate, guanidine sulfamate, guanidine methylol phosphate, or guanidine carbonate; and a metal hydroxide such as potassium hydroxide, sodium hydroxide, and magnesium hydroxide.

Among these, from the viewpoint of an excellent hygroscopic capacity, it is preferable that the hygroscopic agent contains potassium chloride.

The content of the hygroscopic agent in the hygroscopic layer is controlled by the coating amount per unit area. From the viewpoint of achieving both of the hygroscopic capacity and the transparency, the coating amount of the hygroscopic agent is preferably in a range of 1 g/m² to 20 g/m², more preferably in a range of 2.5 g/m² to 15 g/m², and still more preferably in a range of 5 g/m² to 13 g/m².

From the viewpoint of achieving both of the hygroscopic capacity and the transparency, the thickness of the thickest portion of the hygroscopic layer in the present disclosure is preferably in a range of 5 μm to 100 μm, more preferably in a range of 20 μm to 80 μm, and still more preferably in a range of 30 μm to 70 μm. In a case where the thickness of the thickest portion of the hygroscopic layer is in the above-described range, a larger hygroscopic capacity is obtained and both of the hygroscopic capacity and the transparency can be achieved.

The preferable hygroscopic layer of the present disclosure has a porous structure. The porosity of the porous structure is preferably in a range of 45% to 85%, more preferably in a range of 50% to 80%, and particularly preferably in a range of 55% to 75%. In a case where the porosity of the hygroscopic layer is 45% or greater, a larger hygroscopic capacity is obtained. Further, in a case where the porosity of the hygroscopic layer is 85% or less, a decrease in film hardness can be prevented and cracking at the time of drying can be suppressed.

Examples of the method of measuring the porosity include a mercury press-in method and a calculation method of immersing a hygroscopic layer in an organic solvent such as diethylene glycol to measure the void volume based on a change in mass thereof, and measuring the thickness of the hygroscopic layer through observation of the cross section using a microscope.

The average pore diameter of the preferable hygroscopic layer of the present disclosure is preferably 40 nm or less, more preferably 30 nm or less, and particularly preferably 25 nm or less from the viewpoint of the hygroscopic capacity. In a case where the average pore diameter of the hygroscopic layer is 40 nm or less, the transparency is sufficiently obtained.

In the present disclosure, the average pore diameter is a value measured using SHIMADZU AUTOPORE 9220 (trade name, manufactured by Shimadzu Corporation) according to a mercury press-in method.

Support which Contains Resin Having Moisture Permeability and has Roughness in at Least One Surface (Support)

In the present disclosure, the hygroscopic material (for example, the hygroscopic material 10 illustrated in FIG. 1) includes a moisture-permeating resin; a support (for example, the support 12 in FIG. 1) having roughness in at least one surface; a hygroscopic layer (for example, the hygroscopic layer 14 in FIG. 1); and a damp-proof layer (for example, the damp-proof layer 16 in FIG. 1).

As the support, an aspect of a support in which the roughness is formed in a resin sheet formed of a resin having moisture permeability is employed.

The degree of moisture permeability of a resin (hereinafter, also referred to as a moisture-permeating resin) which is contained in the support and has moisture permeability is preferably in a range of 1 g/m²·day to 50 g/m²·day. The degree of moisture permeability in the present specification is a value measured according to the method described in JIS Z 0208 (1976). According to the method, a damp-proof packaging material at a temperature of 25° C. is used as a boundary surface, and a value obtained by converting the mass (g) of water vapor passing through the boundary surface for 24 hours into a value per 1 m² of the material is determined as the degree of moisture permeability of the material in a case where air on one side is in a state of a relative humidity of 90% and air on the other side is in a dry state using a hygroscopic agent.

The support contains a film-forming resin as a moisture-permeating resin and may contain other components as necessary.

Examples of the moisture-permeating resin contained in the support include linear low-density polyethylene (LLDPE), low-density polyethylene (LDPE), high-density polyethylene (HDPE), non-stretched polypropylene (CPP), biaxially stretched polypropylene (OPP), and polyacrylonitrile (PAN). From the viewpoint of versatility, LLDPE or CPP is particularly preferable. In addition, from the viewpoint that high heat sealing strength is obtained in a case of being used as a packaging material, CPP is more preferable.

The thickness of the thinnest portion of the support that contains a moisture-permeating resin is preferably in a range of 10 μm to 200 μm, more preferably in a range of 20 μm to 100 μm, and still more preferably in a range of 25 μm to 80 μm.

In a case where the thickness of the support is in the above-described range, both of the handleability of the entire hygroscopic material and handling properties at the time of obtaining the packaging material or the like can be achieved at higher levels. Therefore, in a case where roughness is formed in the support, it is preferable that the roughness is formed under a condition that the minimum thickness of a recess is set to be in the above-described range.

In addition, roughness may be formed on both surfaces of the support. In a case where the roughness is formed on both surfaces of the support, the hygroscopic layer may be provided on a surface (first surface) on a side where the damp-proof layer of the support is provided, and the hygroscopic layer is not necessarily formed on a surface (second surface) of the support on a side opposite to the first surface. Therefore, the hygroscopic layer disposed in the “recesses of the support” in the present disclosure indicates a hygroscopic layer disposed on the first surface.

The hygroscopic speed of the hygroscopic layer can be controlled by adjusting at least any of the quality of the type or the thickness of the moisture-permeating resin contained in the support of the hygroscopic material of the present disclosure. Further, a difference in the thickest portion and the thinnest portion of the support becomes the maximum thickness of the hygroscopic layer.

In a case where the hygroscopic material of the present disclosure is used as the packaging material, the support containing a moisture-permeating resin can be used as a bonding site. Further, an aspect in which the hygroscopic layer is not in direct contact with the inclusions can be employed in a case where the support is provided on the side of the inclusions of the packaging material.

Damp-Proof Layer

In the present disclosure, the hygroscopic material includes a damp-proof layer (for example, the damp-proof layer 16 illustrated in FIG. 1).

The damp-proof layer is not particularly limited as long as the layer contains a material having dampproofness. It is preferable that the damp-proof layer is a layer having a degree of moisture permeability of less than 1 g/m²·day. As the method of measuring the degree of moisture permeability, the same method as the above-described method used for the support containing a moisture-permeating resin can be employed.

The damp-proof layer may be a layer formed of one material or may have a laminated structure of layers containing two or more materials.

As the damp-proof layer, a resin film with low moisture permeability in which the moisture permeability satisfies the degree of moisture permeability, a laminate formed of different kinds of resin films, a laminated film obtained by vapor-depositing a metal and an inorganic material on a resin film, or a laminated film formed by laminating a resin film and a metal sheet or the like can be appropriately used.

From the viewpoint of excellent dampproofness, a sheet obtained by vapor-depositing a metal on a resin sheet or paper in advance or a metal sheet such as metal foil may be used.

As the material used for the damp-proof layer, from the viewpoint of obtaining sufficient dampproofness, a laminated film that includes a metal layer or an inorganic material layer such as a silica-deposited film, an alumina-deposited film, or an aluminum-deposited film or a metal sheet such as aluminum foil is preferable.

Commercially available products may be used as the damp-proof layer. Examples of the commercially available products include TECHBARRIER MX (trade name, manufactured by Mitsubishi Plastics, Inc.) (in other words, silica-deposited PET) and BARRIALOX (trade name, manufactured by TORAY ADVANCED FILM CO., LTD.) (in other words, alumina-deposited PET).

From the viewpoint of dampproofness, the thickness of the damp-proof layer 16 is preferably in a range of 6 μm to 120 μm and more preferably 6 μm to 100 μm.

Adhesive Layer

In the present disclosure, the hygroscopic material may further include an adhesive layer. The adhesive layer can be provided between the damp-proof layer and the support having the hygroscopic layer that is disposed in the recesses thereof.

The adhesive layer has moisture permeability so that the hygroscopic speed in the hygroscopic layer can be controlled according to the thickness and the type of the adhesive layer. Further, the adhesiveness between the hygroscopic layer (for example, the hygroscopic layer 14 in FIG. 1) and the damp-proof layer (for example, the damp-proof layer 16 in FIG. 1) and the adhesiveness between the hygroscopic layer and the support (for example, the support 12 in FIG. 1) can be further strengthened by providing the adhesive layer as desired.

The type of the adhesive used for the adhesive layer is not particularly limited. Examples of the adhesive include a urethane resin-based adhesive, a polyester-based adhesive, an acrylic resin-based adhesive, an ethylene vinyl acetate resin-based adhesive, a polyvinyl alcohol-based adhesive, a polyamide-based adhesive, and a silicone-based adhesive. Among these, from the viewpoint that the adhesive strength is high, a urethane resin-based adhesive is preferable.

It is preferable that the adhesive layer contains at least one urethane resin-based adhesive. Further, a combination of a urethane resin-based adhesive with one or more adhesives other than the urethane resin-based adhesive is also preferably exemplified.

Commercially available products can be used as the adhesive, and examples of the commercially available products include a urethane resin-based adhesive (trade name: LIS-073-50U, manufactured by TOYO INK CO., LTD.). It is preferable that the adhesive is used in combination with a curing agent (trade name: CR-001, manufactured by TOYO INK CO., LTD.).

From the viewpoints of the adhesive strength and the handling properties at the time of obtaining the packaging material or the like, the thickness of the adhesive layer is preferably in a range of 3 μm to 15 μm and more preferably in a range of 3 μm to 10 μm. In a case where the thickness of the adhesive layer is in the above-described range, both of the adhesive strength and the handling properties at the time of obtaining the packaging material or the like can be achieved at higher levels.

Further, the hygroscopic speed of the hygroscopic layer can be controlled by selecting the thickness in the above-described range.

The adhesive or the like used for forming an adhesive layer may be used alone or in combination of two or more kinds thereof.

As the hygroscopic material of the present disclosure, for example, an aspect of a hygroscopic material which includes the support 12 having roughness; the hygroscopic layer 14 positioned in the recesses of the support; and the damp-proof layer 16 as illustrated in FIG. 1 can be exemplified. The hygroscopic layer may be provided on the top of the projections of the support. However, from the viewpoint of the effect of suppressing moisture permeation, it is preferable that the thickness of the hygroscopic layer present on the projections of the support in the hygroscopic material of the present disclosure is 5 μm or less and more preferable that the hygroscopic layer is not provided on the top of the projections of the support.

Since moisture infiltration from an end portion is suppressed by the projections of the support even in a case where a sealing treatment is not performed on the end portion so that the moisture does not infiltrate into the deep portion of the hygroscopic material, a sufficiently large hygroscopic capacity can be maintained for a long period of time in a case where the hygroscopic material of the present disclosure is used. Therefore, the hygroscopic material of the present disclosure can be suitably used for the packaging material in order to maintain the dry state of inclusions for a long period of time.

<Method of Producing Hygroscopic Material>

A method of producing the hygroscopic material of the present disclosure is not particularly limited.

A known method is appropriately selected and can be used as the method of preparing a support having roughness.

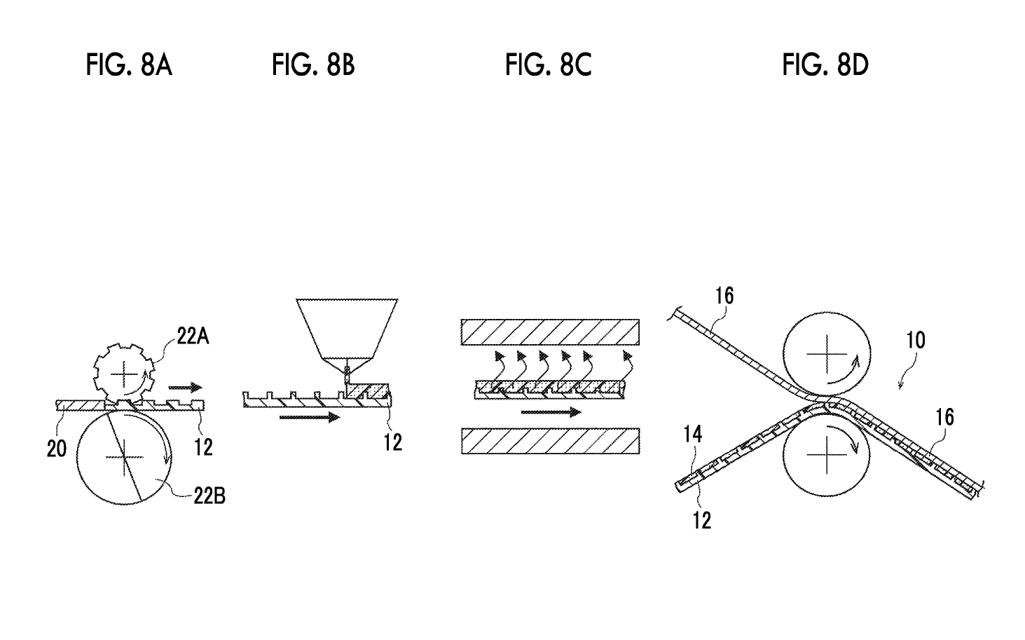

Among examples of the known method, in consideration of the productivity, it is preferable that the hygroscopic material is produced according to the following method of producing a hygroscopic material according to an embodiment. The production method of the present disclosure will be described with reference to FIG. 8. FIGS. 8A to 8D are views schematically illustrating typical processes according to the method of producing the hygroscopic material of the present disclosure.

The method of producing a hygroscopic material of the present disclosure includes forming recesses in a resin sheet having moisture permeability by performing heat embossing to prepare a support having roughness; forming a hygroscopic layer in at least recesses of the support; and forming a damp-proof layer on the support, on which the hygroscopic layer is formed.

Further, it is preferable that the shape of a cross section of a projection included in the support in the hygroscopic material formed according to the production method of the present disclosure is at least one selected from the group consisting of a triangle, a rectangle, a trapezoid, and a mountain shape having a top formed of a straight line.

Forming Recesses in Resin Sheet Having Moisture Permeability by Performing Heat Embossing to Prepare Support Having Roughness

In the present step, for example, roughness is formed in a resin sheet and the support 12 having roughness is prepared by performing heat embossing using an emboss roll 22A and a backup roll 22B while moving a resin sheet 20 having moisture permeability in the arrow direction (longitudinal direction) as illustrated in FIG. 8A.

The heating conditions at the time of embossing may be appropriately selected according to the characteristics of the resin sheet having moisture permeability. For example, the heating temperature is preferably in a range of 80° C. to 100° C. in a case where CPP is used as the moisture-permeating resin sheet. Further, the heating temperature is preferably in a range of 70° C. to 100° C. in a case where LLDPE is used as the moisture-permeating resin sheet.

Since CPP has excellent thermoformability among resins having moisture permeability, it is preferable that a CPP sheet is used as the resin sheet due to the reason that a projection having substantially the same height as the depth of a recess which is a groove of a mold is formed at the time of formation of a pattern of projections so that a support having roughness having designed values can be easily formed.

In the present disclosure, it is preferable that a support having an irregular pattern corresponding to the specific pattern described above is formed.

Grooves according to the irregular pattern formed in the support are formed in an emboss roll used for forming roughness in advance, and thus the projections of the support are formed by the grooves formed in the emboss roll. As the emboss roll used for forming roughness in the support, any of a roll in which recesses are formed for forming projections in the support and a roll on which projections are formed for forming recesses in the support may be used.

Among these, from the viewpoint of easily forming an exact pattern of an emboss roll mold, it is preferable to reduce the deformation region, due to the emboss roll, in the resin sheet where roughness is to be formed. Further, from the viewpoints of easily performing processing using the emboss roll and the productivity, it is preferable that grooves, in other words, recesses are formed in the emboss roll and projections of the support are formed using the emboss roll.

The support having roughness formed in the present step may be wound and stored or directly used for the next step.

In a case where a coating solution for forming a hygroscopic layer used during the formation of the hygroscopic layer in recesses of the support in the next step remains on the top of projections of the support, the coating solution for forming a hygroscopic layer adheres to the top of the projections so that a thin hygroscopic layer is formed. As the result, moisture permeability is degraded in some cases compared to an aspect in which a hygroscopic layer is not present on the top of the roughness. Therefore, it is preferable that the cross-sectional shape of a projection to be formed on the support is a triangle such that the top of the projection does not have a smooth surface. Further, a water repellent treatment may be performed on the top of a projection after the roughness is formed in the support in a case where the cross-sectional shape of the projection is a shape having a flat surface on the top thereof, such as a trapezoid, a rectangle, or a mountain shape.

The water repellent treatment can be performed according to a known method. Examples of the method for the water repellent treatment include a method of coating the top of a projection of the support with a known water repellent agent such as a fluorine-based water repellent agent or a silicone-based water repellent agent; and a method of transferring a porous microstructure from a mold shape to the top of a projection. In a case of the latter method, the water repellent effect due to the lotus effect is exhibited by forming a fine irregular structure on the top of a projection.

Further, roughness may be provided in both surfaces of the support. In this case, the shapes of the roughness formed in both surfaces may be the same as or different from each other.

In a case where the roughness is formed in both surfaces, both rolls can be formed as emboss rolls in a case where moisture-permeating resin sheets are subjected to heat embossing.

There is an advantage that the height of a projection of the support can be further increased in a case where embossing processing is performed on both surfaces. In other words, in a case where a projection with a target height which is sufficiently high cannot be obtained by performing embossing processing on one surface of the support, the height of the projection can be further increased by performing embossing processing on both surfaces, in other words, performing embossing processing for forming recesses in one surface in a region where projections are formed on the other surface in the rear surface of the support. By forming fine roughness in the surface of the support where the hygroscopic layer is not formed using an emboss roll, design properties and blocking resistance can be imparted to the hygroscopic material.

Forming Hygroscopic Layer in at Least Recesses of Support

Next, the hygroscopic layer 14 is formed in at least recesses of the support 12 having roughness in the pre-step as illustrated in FIGS. 8B and 8C.

The hygroscopic layer 14 is formed in at least recesses of the support 12 by coating the support 12 with the coating solution for forming a hygroscopic layer as illustrated in FIG. 8B and drying the coating solution for forming a hygroscopic layer as illustrated in FIG. 8C.

As the hygroscopic layer coating solution, one solution may be applied to the support or two or more solutions may be sequentially applied thereto. For example, in a case of the preferable hygroscopic layer of the present disclosure, a porous layer is firstly formed using a coating solution for forming a porous layer and then a hygroscopic agent coating solution containing a hygroscopic agent is applied to the formed porous layer, thereby forming a hygroscopic layer.

The coating solution for forming a hygroscopic layer can be applied using a known coating device. For example, in FIG. 8B, the coating solution for forming a hygroscopic layer is continuously applied to the support 12 using a hopper while the support 12 is moved in the arrow direction of FIG. 8B.

For example, as illustrated in FIG. 8B, the coating solution for forming a hygroscopic layer may be applied to have a thickness greater than the depth of a recess of the support 12 so that the coating solution for forming a hygroscopic layer or the coating solution for forming a porous layer adheres to the surface of each projection of the support 12. During the process of drying the coating solution for forming a hygroscopic layer or the like to form a hygroscopic layer, a solvent is removed from the coating solution for forming a hygroscopic layer in each recess of the support, the film thickness is reduced, and a hygroscopic layer or a porous layer which is a precursor of a hygroscopic layer which has a thickness suitable for a recess of the support is formed.

In a case where the cross-sectional shape of a projection of the support is a shape other than the triangle, the film thickness of the coating solution for forming a hygroscopic layer adhering to projections of the support is decreased due to the drying, and the coating solution is moved to the adjacent hygroscopic layers (hygroscopic layer portion) in recesses of the support in the middle of the drying and then absorbed. Alternatively, even in a case where the coating solution remains on the top of projections, the coating solution becomes a hygroscopic layer with an extremely small thickness to the extent that moisture transport between adjacent hygroscopic layers (hygroscopic layer portions) does not almost occur. As described above, in a case where a water repellent treatment is performed on the top of the support, the coating solution for forming a hydrophilic hygroscopic layer is repelled by the surface to which the water repellent treatment has been applied and remaining of the coating solution on the top of the projections is suppressed.

FIG. 8B describes the aspect of continuously coating the support with the coating solution for forming a hygroscopic layer, but the method of forming a hygroscopic layer is not limited thereto and a method of locally applying the coating solution for forming a hygroscopic layer to only recesses formed in the support can be used. Examples of the method of locally applying the coating solution for forming a hygroscopic layer include an inkjet printing method.

Next, the method of forming a hygroscopic layer will be described.

According to the preferred aspect of the present disclosure, the hygroscopic layer contains amorphous silica, a water-soluble resin, and a hygroscopic agent. As an example, in the case of forming the suitable hygroscopic layer described above, a method of forming a hygroscopic layer by coating the support with a coating solution that contains amorphous silica and a water-soluble resin, forming a layer that has a porous structure in at least recesses of the support, providing a solution that contains a hygroscopic agent for the porous structure, and impregnating the porous structure with the hygroscopic agent can be used.

By applying the hygroscopic agent to the hygroscopic layer formed on a porous structure obtained by using the coating solution that contains amorphous silica, a state in which the hygroscopic agent is adsorbed on the surface of silica constituting the porous structure is formed. Therefore, the hygroscopic surface can be widely ensured so that the hygroscopic speed increases and the hygroscopic capacity becomes larger. Particularly in a case where the porous structure is formed of vapor phase method silica, transparency is provided and the hygroscopic material has light transmittance (in other words, visibility through a material).

The coating solution for forming a hygroscopic layer, which is used to form the preferable hygroscopic layer of the present disclosure, can be prepared by mixing amorphous silica, a water-soluble resin, and other components such as a dispersant, water, and a cross-linking agent as necessary and performing a dispersing treatment.

For example, vapor phase method silica particles serving as a pigment and a dispersant are added to water and dispersed for a predetermined time (preferably 10 to 30 minutes) under a high-speed rotation condition of 10000 rpm (preferably 5000 to 20000 rpm) using a high-speed rotation wet type colloid mill (for example, trade name: CLEAR MIX, manufactured by M Technique Co., Ltd.) or a liquid-liquid collision type dispersing machine (for example, trade name: ULTIMIZER, manufactured by SUGINO MACHINE LIMITED CO., LTD.), a cross-linking agent (for example, boric acid) and a water-soluble resin (preferably a polyvinyl alcohol aqueous solution) are added thereto, other components are further added thereto as necessary, and the mixture is dispersed therein under the same rotation conditions as described above, thereby preparing a coating solution for forming a hygroscopic layer.

The coating solution to be obtained is a liquid in a sol state with high uniformity, and a hygroscopic layer having a porous structure with a three-dimensional network structure can be formed by coating a support with the coating solution according to an arbitrary coating method and drying the support.

An aqueous dispersion containing amorphous silica and a dispersant may be prepared by preparing an amorphous silica aqueous dispersion liquid in advance and adding the obtained aqueous dispersion liquid to a dispersant aqueous solution, by adding the dispersant aqueous solution to the amorphous silica aqueous dispersion liquid, or by mixing amorphous silica and the dispersant at the same time. In addition, powdery amorphous silica may be added to the dispersant aqueous solution as described above without using the amorphous silica aqueous dispersion liquid.

An aqueous dispersion liquid having an average particle diameter of 20 nm to 5000 nm can be obtained by mixing amorphous silica and a dispersant with each other and finely granulating the obtained mixed solution using a dispersing machine. Particularly in a case of using vapor phase method silica as the amorphous silica, an aqueous dispersion liquid having an average particle diameter of 20 nm to 100 nm can be obtained.

As the dispersing machine, various known dispersing machines of the related art, such as a high-speed rotation dispersing machine, a medium stirring type dispersing machine (a ball mill, a sand mill, or the like), an ultrasonic dispersing machine, a colloid mill dispersing machine, or a high-pressure dispersing machine, can be used. Among these, a stirring type dispersing machine, a colloid mill dispersing machine, and a high-pressure dispersing machine are preferable.

A solvent can be used for preparation of the coating solution. Examples of the solvent include water, an organic solvent, and a mixed solvent of these. Examples of the organic solvent include alcohols such as methanol, ethanol, n-propanol, i-propanol, and methoxypropanol, ketones such as acetone and methyl ethyl ketone, tetrahydrofuran, acetonitrile, ethyl acetate, and toluene.

In a case where the coating solution is applied to the entire surface of the support having roughness, the coating solution can be applied according to a known coating method using a blade coater, an air knife coater, a roll coater, a bar coater, a gravure coater, or a reverse coater. For example, in FIG. 8C, the moisture in the coating solution for forming a hygroscopic layer is evaporated so that drying is performed by heating the support to which the coating solution for forming a hygroscopic layer has been applied using heaters disposed on both sides of the support while the support is moved in the arrow direction in FIG. 8C.

After the coating solution is applied, the hygroscopic layer is dried until showing a decreasing rate of drying. The hygroscopic layer may be dried typically in a temperature range of 40° C. to 180° C. for 0.5 minutes to 10 minutes and preferably for 0.5 minutes to 5 minutes.

By drying the coating solution, the solvent is removed so that the volume of the coating solution is decreased, and a layer having a porous structure is formed in at least recesses of the support.

In a case where the hygroscopic layer having a porous structure is formed, a layer is coated with the coating solution and dried to form a layer (coating layer) having a porous structure, and a solution that contains a basic compound, for example, an ammonium salt of a weak acid such as ammonium carbonate, an alkali metal salt of a weak acid, an alkaline earth metal salt of a weak acid, hydroxyammonium, primary to tertiary amine, primary to tertiary aniline, or pyridine may be provided for the formed layer. A porous structure having an excellent pore structure is obtained by performing this process.

Examples of the method of providing a solution containing a basic compound include a method of further coating the hygroscopic layer with a solution, a method of spraying a solution using a spray or the like, and a method of immersing a support on which a coating layer has been formed in a solution containing a basic compound.

In addition, the solution containing a basic compound may be provided simultaneously with application of the coating solution for forming a hygroscopic layer. In this case, a layer having a porous structure can be obtained by simultaneously coating (multilayer-coating) the support with the coating solution and the solution containing a basic compound such that the coating solution is brought into contact with the support and drying and curing the coating layer.

According to the preferred aspect of the present disclosure as described above, after the layer having a porous structure is formed in at least recesses of the support, a solution containing a hygroscopic agent is applied to the layer, the porous structure is impregnated with the hygroscopic agent, and a hygroscopic layer having voids is formed so as to be positioned in at least recesses of the support.

Examples of the method of applying a solution containing a hygroscopic agent include a method of coating a layer having a porous structure with a solution, a method of spraying a solution using a spray or the like, and a method of immersing the layer having a porous structure in a solution.

In a case where the solution containing a hygroscopic agent is applied to the layer by coating the layer with the solution, the same coating method as the method of applying the coating solution for forming a layer having a porous structure may be exemplified as the coating method.

The solution containing a hygroscopic agent contains at least one hygroscopic agent and may contain other components such as a surfactant and/or a solvent as necessary.

The solution containing a hygroscopic agent can be prepared by adding a hygroscopic agent (for example, an inorganic salt) and additives such as a surfactant as necessary to ion exchange water and stirring the solution.

From the viewpoints of the hygroscopic amount and the hygroscopic speed of the hygroscopic layer, the amount of the solution containing the hygroscopic agent is determined such that the amount of the hygroscopic agent to be provided is set to be preferably in a range of 1 g/m² to 20 g/m² and more preferably in a range of 3 g/m² to 12 g/m².

After the solution containing a hygroscopic agent is provided, the layer is heated typically in a temperature range of 40° C. to 180° C. for 0.5 minutes to 30 minutes, dried, and then cured. It is preferable that the layer is heated in a temperature range of 40° C. to 150° C. for 1 minute to 20 minutes. For example, in a case where the solution contains borax or boric acid as a boron compound, it is preferable that the layer is heated in a temperature range of 60° C. to 100° C. for 0.5 minutes to 15 minutes.

Forming Damp-Proof Layer on Support on which Hygroscopic Layer is Formed

The hygroscopic layer is formed in at least recesses of the support by performing the pre-step. In the present step, for example, the damp-proof layer 16 is formed on a side of the support 12 where the hygroscopic layer 14 is has been formed to obtain the hygroscopic material 10 as illustrated in FIG. 8D. In FIG. 8D, the hygroscopic material 10 is formed by passing the damp-proof layer 16 and the support 12 that holds the dried hygroscopic layer 14 through a space between two rotating rollers respectively in the directions indicated by the arrows in FIG. 8D while applying a pressure thereto.

A method of forming a damp-proof layer is not particularly limited, and the damp-proof layer may be formed by adhering a material having dampproofness to the side where the hygroscopic layer positioned in at least recesses of the support is formed. Further, the damp-proof layer may be formed by preparing a coating solution that contains a material having dampproofness, coating the support that includes the hygroscopic layer positioned in at least recesses thereof with the coating solution, and drying the coating solution.

In the present disclosure, since the support that includes the hygroscopic layer formed in at least recesses does not have roughness in the surface thereof, it is preferable that the damp-proof layer is formed through adhesion from the viewpoint of the productivity.

As described in the section of the hygroscopic material, a layer formed of a material having a degree of moisture permeability of less than 1 g/m²·day is preferable as the damp-proof layer, and it is preferable that the layer is formed using a resin film having a single layer structure or a laminated structure with low moisture permeability or a film on which a metal or an inorganic material is vapor-deposited.

The damp-proof layer can be formed by bonding the above-described film used for forming a damp-proof layer to a side of the hygroscopic layer formed in at least recesses of the support.

From the viewpoint of further improving the adhesiveness between the damp-proof layer and the hygroscopic layer, it is preferable that the adhesive layer is formed on the film for forming a damp-proof layer during the formation of the damp-proof layer and the hygroscopic layer and the damp-proof layer, and the support and the damp-proof layer are respectively bonded to each other through the adhesive layer. By interposing the adhesive layer therebetween, the damp-proof layer is strongly bonded to the support and thus the function for suppressing moisture permeation between adjacent hygroscopic layers (hygroscopic layer portions) which are separated by projections of the support is further improved.

<Packaging Material>

The hygroscopic material of the present disclosure may be used as the packaging material. The packaging material of the present disclosure is a packaging material containing the above-described hygroscopic material of the present disclosure.

Examples of the form of the packaging material include a sheet form and a bag form. In a case where the hygroscopic material of the present disclosure is used as the packaging material, the material can be used in the form described below, but the form of the packaging material is not limited to the following examples.

As one aspect of the packaging material, an aspect in which a hygroscopic material in one sheet form whose one surface has a hygroscopic layer is formed into a bag form by setting the support side to face the inside and the damp-proof layer side to face the outside, a bonding site formed by bonding at least some portions of the support is provided at the peripheral edge in the bag form, and the inclusions that require moisture absorption are put inside the packaging material may be exemplified.

In a case of a material in which the moisture-permeating resin constituting the support can be thermally fused, the bonding site may be formed by thermal fusion or may be formed by bonding a pair of supports to each other through an adhesive layer or an easily adhesive sheet.

As the method of forming the hygroscopic material in a bag form, in addition to a method of folding one sheet of hygroscopic material and bonding overlapping supports to each other at the end portion, a method of overlapping two sheets of hygroscopic materials by setting the support to face the inside and the damp-proof layer to face the outside and bonding the supports at the end portion to each other may be exemplified.

Examples of other aspects of the packaging material include an aspect in which supports of two different kinds of hygroscopic materials overlap each other and the peripheral edges are bonded to each other to obtain a bag form and an aspect in which a damp-proof sheet and a hygroscopic material overlap each other by bringing a support side of the hygroscopic material into contact with the damp-proof sheet and the peripheral edges are bonded to each other to obtain a bag form.

Further, a hygroscopic material provided with a recess serving as a housing portion is obtained by forming the hygroscopic material in advance, and the form of the packaging material including a housing portion which is formed by bonding the support in a portion where a recess is not formed on an opening surface side of the recess of the hygroscopic material to another damp-proof sheet can be obtained.

As a specific example, the packaging material of the present disclosure can also be applied to blister pack (also referred to as PTP packaging) used for packaging medicine or the like which is provided with a recess housing inclusions.

Even in all the forms of the packaging material, as the bonding method, a known bonding method such as thermocompression bonding, thermal fusion, ultrasonic bonding, bonding through an adhesive, or bonding through an easily adhesive sheet can be applied according to the purpose thereof.

The packaging material of the present disclosure is capable of maintaining the dry state of inclusions for a long period of time because infiltration of moisture from the cutting end portion to the deep portion of the hygroscopic material constituting the packaging material is suppressed without performing a sealing treatment on the end portion and a sufficiently large hygroscopic capacity can be maintained for a long period of time.

### EXAMPLES

Hereinafter, the present invention will be described in more detail with reference to examples, but the present invention is not limited to the following examples unless the present invention goes beyond the gist thereof. Further, “part” and “%” are on a mass basis unless otherwise noted.

### Example 1

A hygroscopic material of Example 1 was prepared by performing the following processes.

<Preparation of Support Having Roughness>

Preparation of Emboss Roll

An emboss roll having V-shaped grooves respectively with a width of 300 μm (half-width of 150 μm) and a depth of 50 μm on the roll surface at intervals of 20 mm in the longitudinal direction and intervals of 20 mm in the lateral direction was prepared as an emboss roll for forming a support of Example 1, in a case where the circumferential direction of the roll for forming roughness of the support was defined as the longitudinal direction and the width direction orthogonal to the circumferential direction was defined as the lateral direction.

Shaping of Support

Embossing processing was performed on one surface of a non-stretched polypropylene (CPP) film (trade name: FHK2, manufactured by FUTAMURA CHEMICAL CO., LTD.) at an emboss temperature of 90° C. having a thickness of 60 μm using a backup roll and the emboss roll in which the above-described V-shaped grooves were formed. As the result, the support was shaped such that the cross-sectional shape of a projection was a triangle and projections respectively having a height of 50 μm were disposed at intervals of 20 mm in the longitudinal direction and at intervals of 20 mm in the lateral direction. The support used in Example 1 is a support having projections indicated by oblique lines in the plan view of FIG. 6A. The cross-sectional shape of a projection of the support used for forming a hygroscopic material of Example 1 is a triangle having a height of 50 μm, a width of the bottom surface of 300 μm, and a half-width of 150 μm. The thickness of the thinnest portion of the support was measured and the value was 60 μm

It is considered that the thickness of the thinnest portion of the support after formation of projections is the same as the thickness of the resin sheet before the formation because the thickness of the resin sheet before formation of projections becomes substantially the same as the thickness of the support after the formation of projections due to deformation of CPP in the groove shape along the V-shaped grooves of the emboss roll.

The thickness of the thinnest portion of a recess in the cross-sectional shape and the size of a projection in the cross-sectional shape of the support having roughness in each example and each comparative example were values obtained by observing a cross section formed by cutting the shaped support in the width direction (direction indicated by the broken line in FIG. 3) using a desk top microscope Miniscope TM-1000 (manufactured by Hitachi High-Technologies Corporation) and reading the dimensions from a scale bar on the observation image.

For example, the support obtained in Example 1 was formed such that a plurality of recesses respectively having a size of 20 mm×20 mm and a depth of 50 μm were formed by being separated from one another due to walls, each of which had a triangular cross-sectional shape with a half-width of 150 μm.

<Formation of Hygroscopic Layer>

Preparation of Coating Solution for Forming Hygroscopic Layer

As shown in the following composition, (1) vapor phase method silica 1, (2) ion exchange water, (3) SHALLOL DC-902P (trade name), and (4) ZIRCOSOL ZA-30 (trade name) were mixed and dispersed using a liquid-liquid collision type dispersion machine (ULTIMIZER, manufactured by SUGINO MACHINE LIMITED CO., LTD.) (this step is referred to as a silica dispersing treatment as appropriate). Thereafter, the obtained dispersion liquid was heated at 45° C. and held for 20 minutes. Next, the dispersion liquid was held at 30° C., (5) and a boric acid aqueous solution and (6) a polyvinyl alcohol (PVA)-dissolved solution were added to the dispersion liquid, thereby preparing a coating solution for forming a hygroscopic layer.

Composition of Coating Solution for Forming Hygroscopic Layer

| | |
|---|---|
| (1) Vapor phase method silica 1 (amorphous silica) | 8.9 parts |
| (trade name: AEROSIL 300 SF75, manufactured by | |
| NIPPON AEROSIL CO., LTD., average primary particle | |
| diameter: 7 nm, average secondary particle diameter: | |
| 20 nm) | |
| (2) Ion exchange water | 47.3 parts |
| (3) SHALLOL DC-902P (trade name, manufactured by | 0.8 parts |
| DKS Co., Ltd.) (51.5% aqueous solution) (dispersant, | |
| nitrogen-containing organic cationic polymer) | |
| (4) ZIRCOSOL ZA-30 (trade name, manufactured by | 0.5 parts |
| DAIICHI KIGENSO KAGAKU KOGYO CO., LTD.) | |
| (zirconyl acetate) | |
| (5) Boric acid (5% aqueous solution) | 6.6 parts |
| (6) Polyvinyl alcohol (water-soluble resin)-dissolved | 26.0 parts |
| solution | |

Composition of Polyvinyl Alcohol (PVA)-Dissolved Solution

| | |
|---|---|
| JM33 (trade name, manufactured by JAPAN VAM & POVAL | 1.81 parts |
| CO., LTD.) (polyvinyl alcohol; degree of saponification: | |
| 95.5%, degree of polymerization: 3300) | |
| HPC-SSL (trade name, manufactured by Nippon Soda Co., | 0.08 parts |
| Ltd.) (water-soluble cellulose) | |
| Ion exchange water | 23.5 parts |
| Diethylene glycol monobutyl ether | 0.55 parts |
| (trade name: BUTYCENOL 20p, manufactured by Kyowa | |
| Hakko Chemical Co., Ltd.) | |
| Polyoxyethylene lauryl ether (surfactant) | 0.06 parts |
| (trade name: EMULGEN 109P, manufactured by Kao | |
| Corporation) | |

Formation of Hygroscopic Layer

A support having roughness was coated with the obtained coating solution for forming a hygroscopic layer obtained in the above-described manner using an extrusion die coater such that the coating amount thereof after the coating solution was dried was set to have a film thickness of 30 μm.

A coating layer formed by coating the support was dried under conditions of a temperature of 80° C. at a wind speed of 3 m/sec to 8 m/sec using a hot air dryer. The coating layer during the drying exhibited the constant rate of drying. Immediately after the drying was finished, the coating layer was immersed in a liquid containing a basic compound with the following composition for 3 seconds, and the liquid containing the basic compound was allowed to adhere to the coating layer such that the coating amount thereof was set to 13 g/m². Further, the coating layer was dried in an environment of 72° C. for 10 minutes, thereby forming a layer having a porous structure.

Thereafter, the formed layer was coated with a hygroscopic agent coating solution with the following composition using an extrusion die coater such that the coating amount thereof was set to 50 g/m² (in other words, CaCl₂ application amount: 7 g/m²) and dried under conditions of a temperature of 80° C. at a wind speed of 3 m/sec to 8 m/sec using a hot air dryer, thereby obtaining a hygroscopic layer having a thickness of 30 μm in recesses of the support. The thickness of the hygroscopic layer formed in Example 1 was the maximum thickness and the results thereof are listed in Tables 1 and 2. These results are listed in Tables 1 and 2 under the item name of “thickness”.

The porosity of the formed hygroscopic layer was 60% and the average pore size thereof was 20 nm.

Composition of Liquid Containing Basic Compound

| | |
|---|---|
| (1) Boric acid | 0.65 parts |
| (2) Ammonium carbonate (primary, manufactured by | 5.0 parts |
| Kanto Chemical Co., Inc.) | |
| (3) Ion exchange water | 93.75 parts |
| (4) Polyoxyethylene lauryl ether (surfactant) | 0.6 parts |
| (trade name: EMULGEN 109P, manufactured by Kao | |
| Corporation) | |

Composition of Hygroscopic Agent Coating Solution

| | |
|---|---|
| (1) Boric acid | 0.65 parts |
| (2) Ammonium carbonate (primary, manufactured by | 5.0 parts |
| Kanto Chemical Co., Inc.) | |
| (3) Ion exchange water | 93.75 parts |
| (4) Polyoxyethylene lauryl ether (surfactant) | 0.6 parts |
| (trade name: EMULGEN 109P, manufactured by Kao | |
| Corporation) | |

Forming Damp-Proof Layer on Support on which Hygroscopic Layer was Formed

A silica-deposited surface of silica-deposited PET (trade name: TECH BARRIER MX, manufactured by Mitsubishi Plastics, Inc.) serving as a damp-proof layer was coated with an adhesive (that is, mixture of LIS-073-50U (trade name) serving as a urethane resin-based adhesive and CR-001 (trade name) serving as a curing agent, manufactured by TOYO INK CO., LTD.) such that the coating amount thereof after drying of the layer was set to have a thickness of 3.5 μm. The silica-deposited PET obtained in the pre-step was allowed to overlap the support in a direction in which the support and the adhesive were in contact with each other on a side where the hygroscopic layer of the support including the hygroscopic layer positioned in the recesses of the support with roughness was positioned and allowed to adhere thereto through dry lamination. In this manner, a hygroscopic material of Example 1 was obtained.

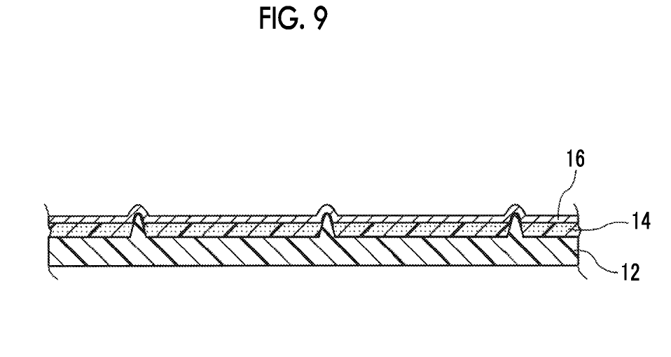

FIG. 9 is a cross-sectional view schematically illustrating the obtained hygroscopic material of Example 1. The hygroscopic material of Example 1 contains CPP serving as a moisture-permeating resin and is configured to have a laminated structure of the support 12 having roughness, the hygroscopic layer 14 positioned in recesses of the support, the adhesive layer (not illustrated), and the silica-deposited PET serving as the damp-proof layer 16 (in other words, the adhesive layer was formed on the silica-deposited surface of the silica-deposited PET).

According to the method described in FIGS. 7A and 7B, the hygroscopic material of Example 1 was observed in a plan view and the area ratio of the region occupied by the hygroscopic layer to the entire region at the time at which the hygroscopic material was seen in a plan view was measured. In a case where the area enclosed by the broken lines corresponding to the entire region of the hygroscopic material is set as Sa as illustrated in FIG. 7A, Sa is calculated by an equation of (0.15+20+0.15) (mm)×(0.15+20+0.15) (mm)=412.09 (mm²). In a case where the area enclosed by solid lines corresponding to the region forming the hygroscopic layer is set as Sb, Sb is calculated by an equation of 20 (mm)×20 (mm)=400 (mm²). The area ratio therebetween (Sb/Sa) is 0.971 and the area ratio of the region occupied by the hygroscopic layer to the entire region of the hygroscopic material is 97.1%.

Moreover, in each example described below, the cross-sectional shape of a projection, the height, the interval, the thickness, the maximum thickness of the hygroscopic layer, the occupied area ratio, the porosity, and the like in the support were measured in the following each example. The results are listed in Tables 1 and 2.

### Example 2

A hygroscopic material of Example 2 was obtained in the same manner as in Example 1 except that an emboss roll having V-shaped grooves respectively with a width of 200 μm (half-width of 100 μm) and a depth of 50 μm on the roll surface at intervals of 20 mm in the longitudinal direction and intervals of 20 mm in the lateral direction was prepared and the obtained emboss roll was used for shaping of the support, in the emboss roll prepared for forming the support of Example 1.

### Example 3

A hygroscopic material of Example 3 was obtained in the same manner as in Example 1 except that an emboss roll having V-shaped grooves respectively with a width of 300 μm (half-width of 150 μm) and a depth of 50 μm on the roll surface at intervals of 5 mm in the longitudinal direction and intervals of 5 mm in the lateral direction was prepared and the obtained emboss roll was used for shaping of the support, in the emboss roll prepared for forming the support of Example 1.

### Example 4

A support was prepared in the same manner as in Example 3 using the same emboss roll as in Example 3. A hygroscopic material of Example 4 was obtained in the same manner as in Example 3 except that the thickness of the hygroscopic layer in a recess of the support was changed from 30 μm to 4 μm.

### Example 5

A support was prepared in the same manner as in Example 3 using the same emboss roll as in Example 3. A hygroscopic material of Example 5 was obtained in the same manner as in Example 3 except that the thickness of the hygroscopic layer in a recess of the support was changed from 30 μm to 25 μm.

### Example 6

A support was prepared in the same manner as in Example 3 using the same emboss roll as in Example 3. A hygroscopic material of Example 6 was obtained in the same manner as in Example 3 except that the thickness of the hygroscopic layer in a recess of the support was changed from 30 μm to 40 μm.

### Example 7

A support was prepared in the same manner as in Example 3 using the same emboss roll as in Example 3. A hygroscopic material of Example 7 was obtained in the same manner as in Example 3 except that the thickness of the hygroscopic layer in a recess of the support was changed from 30 μm to 50 μm.

### Example 8

A support was prepared in the same manner as in Example 3 using the same emboss roll as in Example 3. A hygroscopic material of Example 8 was obtained in the same manner as in Example 3 except that the thickness of the hygroscopic layer in a recess of the support was changed from 30 μm to 20 μm.

### Example 9

A hygroscopic material of Example 9 was obtained in the same manner as in Example 1 except that an emboss roll having V-shaped grooves respectively with a width of 300 μm (half-width of 150 μm) and a depth of 50 μm on the roll surface at intervals of 0.6 mm in the longitudinal direction and intervals of 0.6 mm in the lateral direction was prepared and the obtained emboss roll was used for shaping of the support, in the emboss roll prepared for forming the support of Example 1.

### Example 10

A hygroscopic material of Example 10 was obtained in the same manner as in Example 1 except that an emboss roll having V-shaped grooves respectively with a width of 300 μm (half-width of 150 μm) and a depth of 50 μm on the roll surface at intervals of 1 mm in the longitudinal direction and intervals of 1 mm in the lateral direction was prepared and the obtained emboss roll was used for shaping of the support, in the emboss roll prepared for forming the support of Example 1.

### Example 11

A hygroscopic material of Example 11 was obtained in the same manner as in Example 1 except that an emboss roll having V-shaped grooves respectively with a width of 2400 μm (half-width of 1200 μm) and a depth of 50 μm on the roll surface at intervals of 7.1 mm in the longitudinal direction and intervals of 7.1 mm in the lateral direction was prepared and the obtained emboss roll was used for shaping of the support, in the emboss roll prepared for forming the support of Example 1.

### Example 12

A hygroscopic material of Example 12 was obtained in the same manner as in Example 1 except that an emboss roll having V-shaped grooves respectively with a width of 100 μm (half-width of 50 μm) and a depth of 50 μm on the roll surface at intervals of 4.8 mm in the longitudinal direction and intervals of 4.8 mm in the lateral direction was prepared and the obtained emboss roll was used for shaping of the support, in the emboss roll prepared for forming the support of Example 1.

### Example 13

A hygroscopic material of Example 13 was obtained in the same manner as in Example 1 except that an emboss roll having V-shaped grooves respectively with a width of 600 μm (half-width of 300 μm) and a depth of 50 μm on the roll surface at intervals of 5 mm in the longitudinal direction and intervals of 5 mm in the lateral direction was prepared and the obtained emboss roll was used for shaping of the support, in the emboss roll prepared for forming the support of Example 1.

### Example 14

A support was prepared by being shaped into a film having a thickness of 80 μm which was the same CPP film as in Example 1 using the same emboss roll as in Example 3. A hygroscopic material of Example 14 was obtained in the same manner as in Example 1 except that the obtained support was used.

### Example 15

A hygroscopic material of Example 15 was obtained in the same manner as in Example 1 except that an emboss roll having rectangular grooves respectively with a width of 300 μm (half-width of 150 μm) and a depth of 50 μm and a flat bottom portion (the width of each bottom portion was 150 μm) on the roll surface at intervals of 5 mm in the longitudinal direction and intervals of 5 mm in the lateral direction was prepared and the obtained emboss roll was used for shaping of the support, in the emboss roll prepared for forming the support of Example 1.

### Example 16

A hygroscopic material of Example 16 was obtained in the same manner as in Example 1 except that an emboss roll having inverse mountain-shaped grooves respectively with a width of 300 μm (half-width of 150 μm) and a depth of 50 μm and a flat bottom portion (the width of each bottom portion was 100 μm) on the roll surface at intervals of 5 mm in the longitudinal direction and intervals of 5 mm in the lateral direction was prepared and the obtained emboss roll was used for shaping of the support, in the emboss roll prepared for forming the support of Example 1.

### Example 17

A support was prepared by being shaped into a CPP film having a thickness of 250 which was the same CPP film as in Example 1 using the same emboss roll as in Example 3. A hygroscopic material of Example 17 was obtained in the same manner as in Example 1 except that the obtained support was used. The hygroscopic material of Example 17 may have a problem of handleability since the thickness of the support is large. Therefore, compared to other examples, there is a concern that the hygroscopic layer is cracked at the time of handling the hygroscopic material or the adhesiveness between the hygroscopic layer and the damp-proof layer is easily degraded.

### Example 18

A support was prepared by being shaped into an LLDPE film having a thickness of 60 (trade name: UNILAX LS-760C, manufactured by Idemitsu Kosan Co., Ltd.) using the same emboss roll as the emboss roll used for shaping the support of Example 3. A hygroscopic material of Example 18 was obtained in the same manner as in Example 1 except that the obtained support was used.

### Example 19

A hygroscopic material of Example 19 was obtained in the same manner as in Example 1 except that the hygroscopic layer was formed using the same amount of JP33 (trade name, manufactured by JAPAN VAM & POVAL CO., LTD.) (polyvinyl alcohol, degree of saponification of 88%, degree of polymerization of 4500) as PVA in place of PVA JM33 used for preparing the hygroscopic layer in Example 1.

### Example 20

An emboss roll having V-shaped grooves respectively with a width of 300 μm (half-width of 150 μm) and a depth of 80 μm on the roll surface at intervals of 20 mm in the longitudinal direction and intervals of 20 mm in the lateral direction was prepared, in the emboss roll prepared for forming the support of Example 1. A support having projections respectively with a height of 80 μm was prepared using the obtained emboss roll for shaping the support. A hygroscopic material of Example 20 was obtained in the same manner as in Example 1 except that the thickness of the hygroscopic layer in recesses of the obtained support was changed from 30 μm to 70 μm.

### Example 21

A support was prepared in the same manner as in Example 3 using the same emboss roll as in Example 3. A hygroscopic material of Example 21 was obtained in the same manner as in Example 1 except that the thickness of the hygroscopic layer in recesses of the support was changed from 30 μm to 57 μm. In the hygroscopic material of Example 21, since the thickness of the formed hygroscopic layer was greater than the height (50 μm) of a projection of the support, the support was formed such that the hygroscopic layer having a thickness of 7 μm was present not only in the recesses but also on the surfaces of the projections of the support. Therefore, the thickness of the hygroscopic layer varies between the region where recesses of the support were formed and on the surfaces of projections of the support, but the occupied area of the hygroscopic layer at the time at which the hygroscopic material was seen in a plan view is 100.0%.

### Comparative Example

A hygroscopic material was formed in the same manner as in Example 1 except that the embossing processing was not performed on the CPP resin sheet used for the support and a hygroscopic layer having a uniform thickness of 30 μm was formed in Example 1, and a damp-proof layer was allowed to adhere to the surface of the hygroscopic layer having a uniform thickness in the same manner as in Example 1, thereby obtaining a hygroscopic material of Comparative Example 1.

Evaluation

The hygroscopic materials obtained in the above-described manner were evaluated as follows.

Further, the area ratio of the region where the hygroscopic layer was formed to the entire region of the hygroscopic material was calculated in the same manner as in Example 1.

The results are listed in Tables 1 and 2.

<Hygroscopic Capacity>

The hygroscopic capacity of the hygroscopic material was evaluated in the following manner.

A sample of the hygroscopic material having a size of 100 mm×100 mm was stored in a thermohygrostat bath under a temperature condition of 60° C. at a relative humidity of 10% for 1 hour and dried. The mass of the sample immediately after being transferred to an environment at a temperature of 23° C. and a relative humidity of 50% was measured and was set as the mass in a dry state. Thereafter, a change in mass with time was measured and the hygroscopic capacity was acquired from the mass at the time at which the mass did not change any more.

<Evaluation Standard>

A: The hygroscopic capacity under a temperature condition of 23° C. at a relative humidity of 50% was 10 g/m² or greater.

B: The hygroscopic capacity under a temperature condition of 23° C. at a relative humidity of 50% was 8 g/m² or greater and less than 10 g/m².

C: The hygroscopic capacity under a temperature condition of 23° C. at a relative humidity of 50% was 6 g/m² or greater and less than 8 g/m².

D: The hygroscopic capacity under a temperature condition of 23° C. at a relative humidity of 50% was 3 g/m² or greater and less than 6 g/m².

E: The hygroscopic capacity under a temperature condition of 23° C. at a relative humidity of 50% was less than 3 g/m².

Further, the standards A to C are in levels with no practical problems.

<Hygroscopic Amount from End Surface>

The hygroscopic amount of the hygroscopic material from the end surface was evaluated in the following manner.

Two sheets of samples of the hygroscopic material having a size of 100 mm×100 mm were stored in a thermohygrostat bath under a temperature condition of 60° C. at a relative humidity of 10% for 1 hour and dried. Thereafter, two sheets of samples of the hygroscopic material and the CPP sheet side used for the support were allowed to combine and overlap each other, the peripheral edge end portions of the four sides were heat-sealed, and two sheets were bonded to each other to obtain a sample for measuring the hygroscopic amount from the end surface.

The mass of the obtained sample immediately after being transferred to an environment at a temperature of 23° C. and a relative humidity of 50% was measured and was set as the mass in a dry state. Thereafter, the sample was stored in an environment at a temperature of 23° C. and a relative humidity of 50% for 30 days, the mass of the sample with time was measured, a difference between the mass in a dry state and the mass with time was set as the hygroscopic amount from the end surface, and the evaluation was performed based on the following standard.

<Evaluation Standard>

A: The hygroscopic amount from the end surface was less than 0.3 g/m².

B: The hygroscopic amount from the end surface was 0.3 g/m² or greater and less than 0.5 g/m².

C: The hygroscopic amount from the end surface was 0.5 g/m² or greater and less than 1.0 g/m².

D: The hygroscopic amount from the end surface was 1.0 g/m² or greater and less than 2.0 g/m².

E: The hygroscopic amount from the end surface was 2.0 g/m² or greater.

Further, the standards A to C are in levels with no practical problems.

<Porosity>

The porosity of the hygroscopic layer was acquired from the void volume per unit thickness to be calculated from the void volume (ml/m²) and the thickness (μm) of the hygroscopic layer.

The porosity was measured with respect to the hygroscopic layer before the peeling step using an adhesive was performed, and the thickness of the hygroscopic layer was acquired from the results of observation using an optical microscope. Further, the void volume of the hygroscopic layer was obtained by adding 1 ml of diethylene glycol dropwise onto the hygroscopic layer, wiping the dropped surface with cloth after 1 minute from the dropping, and calculating the change in mass before and after the dropwise addition (in other words, the amount of the absorption liquid per unit area). This calculated value was set as the void volume. Further, the porosity of the hygroscopic layer in the hygroscopic material already prepared can be measured using a sample obtained by cutting the hygroscopic layer.

TABLE 1

| | Hygroscopic material | | | | | | | | |
|---|---|---|---|---|---|---|---|---|---|
| | Support | | | | | | | | |
| | | Cross- | Half-width | | Thickness | Interval | Hygroscopic layer | | |
| | Moisture- | sectional | of | Height of | of thinnest | between | | Occupied | |
| | permeating | shape of | projection | projection | portion | projections | Thickness | area ratio | Porosity |
| | resin | projection | (μm) | (μm) | (μm) | (mm) | (μm) | (%) | (%) |
| Example 1 | CPP | Triangle | 150 | 50 | 60 | 20.3 | 30 | 97.1 | 60 |
| Example 2 | CPP | Triangle | 100 | 50 | 60 | 20.2 | 30 | 98.0 | 60 |
| Example 3 | CPP | Triangle | 150 | 50 | 60 | 5.3 | 30 | 89.0 | 60 |
| Example 4 | CPP | Triangle | 150 | 50 | 60 | 5.3 | 4 | 89.0 | 60 |
| Example 5 | CPP | Triangle | 150 | 50 | 60 | 5.3 | 25 | 89.0 | 60 |
| Example 6 | CPP | Triangle | 150 | 50 | 60 | 5.3 | 40 | 89.0 | 60 |
| Example 7 | CPP | Triangle | 150 | 50 | 60 | 5.3 | 50 | 89.0 | 60 |
| Example 8 | CPP | Triangle | 150 | 50 | 60 | 5.3 | 20 | 89.0 | 60 |
| Example 9 | CPP | Triangle | 150 | 50 | 60 | 0.9 | 30 | 44 | 60 |
| Example 10 | CPP | Triangle | 150 | 50 | 60 | 1.3 | 30 | 60.0 | 60 |
| Example 11 | CPP | Triangle | 1200 | 50 | 60 | 7.4 | 30 | 45.7 | 60 |

| | | | Evaluation of | |
|---|---|---|---|---|
| | Hygroscopic material | | performance | |
| | Damp-proof layer | | | Hygroscopic |
| | | Thickness | Hygroscopic | amount from |
| | Material | (μm) | capacity | end surface |
| Example 1 | Silica-deposited | 12 | A | A |
| | PET | | | |
| Example 2 | Silica-deposited | 12 | A | B |
| | PET | | | |
| Example 3 | Silica-deposited | 12 | A | A |
| | PET | | | |
| Example 4 | Silica-deposited | 12 | C | A |
| | PET | | | |
| Example 5 | Silica-deposited | 12 | B | A |
| | PET | | | |
| Example 6 | Silica-deposited | 12 | A | A |
| | PET | | | |
| Example 7 | Silica-deposited | 12 | A | A |
| | PET | | | |
| Example 8 | Silica-deposited | 12 | B | A |
| | PET | | | |
| Example 9 | Silica-deposited | 12 | C | A |
| | PET | | | |
| Example 10 | Silica-deposited | 12 | B | A |
| | PET | | | |
| Example 11 | Silica-deposited | 12 | C | A |
| | PET | | | |

TABLE 2

| | Hygroscopic material | | | | | | | | |
|---|---|---|---|---|---|---|---|---|---|
| | Support | | | | | | | | |
| | | Cross- | Half-width | | Thickness | Interval | Hygroscopic layer | | |
| | Moisture- | sectional | of | Height of | of thinnest | between | | Occupied | |
| | permeating | shape of | projection | projection | portion | projections | Thickness | area ratio | Porosity |
| | resin | projection | (μm) | (μm) | (μm) | (mm) | (μm) | (%) | (%) |
| Example 12 | CPP | Triangle | 50 | 50 | 60 | 5.1 | 30 | 96.1 | 60 |
| Example 13 | CPP | Triangle | 300 | 50 | 60 | 5.6 | 30 | 79.7 | 60 |
| Example 14 | CPP | Triangle | 150 | 50 | 80 | 5.3 | 30 | 89.0 | 60 |
| Example 15 | CPP | Rectangle | 150 | 50 | 60 | 5.3 | 30 | 89.0 | 60 |
| Example 16 | CPP | Mountain | 150 | 50 | 60 | 5.3 | 30 | 89.0 | 60 |
| | | shape | | | | | | | |
| Example 17 | CPP | Triangle | 150 | 50 | 250 | 5.3 | 30 | 89.0 | 60 |
| Example 18 | LLDPE | Triangle | 150 | 50 | 60 | 5.3 | 30 | 97.1 | 60 |
| Example 19 | CPP | Triangle | 150 | 50 | 60 | 20.3 | 30 | 97.1 | 60 |
| Example 20 | CPP | Triangle | 150 | 80 | 60 | 20.3 | 70 | 97.1 | 60 |
| Example 21 | CPP | Triangle | 150 | 50 | 60 | 20.3 | 57 | 100.0 | 60 |
| Comparative | CPP | None | None | — | 60 | — | 30 | 100.0 | 60 |
| Example 1 | | | | | | | | | |

| | | | Evaluation of | |
|---|---|---|---|---|
| | Hygroscopic material | | performance | |
| | Damp-proof layer | | | Hygroscopic |
| | | Thickness | Hygroscopic | amount from |
| | Material | (μm) | capacity | end surface |
| Example 12 | Silica-deposited | 12 | A | C |
| | PET | | | |
| Example 13 | Silica-deposited | 12 | B | A |
| | PET | | | |
| Example 14 | Silica-deposited | 12 | A | A |
| | PET | | | |
| Example 15 | Silica-deposited | 12 | A | C |
| | PET | | | |
| Example 16 | Silica-deposited | 12 | A | B |
| | PET | | | |
| Example 17 | Silica-deposited | 12 | A | C |
| | PET | | | |
| Example 18 | Silica-deposited | 12 | A | A |
| | PET | | | |
| Example 19 | Silica-deposited | 12 | A | A |
| | PET | | | |
| Example 20 | Silica-deposited | 12 | A | A |
| | PET | | | |
| Example 21 | Silica-deposited | 12 | A | C |
| | PET | | | |
| Comparative | Silica-deposited | 12 | A | D |
| Example 1 | PET | | | |

Further, the mountain shape among the cross-sectional shapes of recesses of the supports in Table 2 is the shape illustrated in FIG. 4D and the rectangular shape thereof is the shape illustrated in FIG. 4C.

As shown in the evaluation results listed in Tables 1 and 2, it was understood that the hygroscopic material of each example has a large hygroscopic capacity and absorption of moisture from an end portion is suppressed even in a case where a special sealing treatment is not performed on the end portion.

On the contrary, in a case of the hygroscopic material of Comparative Example 1 which does not have projections of the support which are used for partitioning the hygroscopic layer and has the hygroscopic layer with a uniform thickness, it was understood that, even though the initial hygroscopic capacity is in a level with no practical problems, the moisture absorption amount from an end portion is large so that it is difficult to expect maintenance of an excellent hygroscopic capacity for a long period of time and to use the hygroscopic material for a long period of time.

The disclosure of JP2015-195271 filed on Sep. 30, 2015 is incorporated in the present specification by reference.

All documents, patent applications, and technical standards described in the present specification are incorporated herein by reference to the same extent as a case of being specifically and individually noted that individual documents, patent applications, and technical standards are incorporated by reference.

What is claimed is:

1. A hygroscopic material comprising:
a support which contains a resin having moisture permeability and has roughness in at least one surface thereof;
a hygroscopic layer which is disposed at least in recesses of one surface of the support; and
a damp-proof layer which is disposed on the support and the hygroscopic layer disposed on the one surface of the support.

2. The hygroscopic material according to claim 1,
wherein the thickness of the thickest portion of the hygroscopic layer is in a range of 5 μm to 100 μm.

3. The hygroscopic material according to claim 1,
wherein an area ratio of a region occupied by the hygroscopic layer to the entire region of the hygroscopic material is in a range of 50% or greater and less than 100% in a plan view.

4. The hygroscopic material according to claim 1,
wherein the shape of a cross section of a projection included in the support orthogonal to a plane direction of the support is at least one selected from the group consisting of a triangle, a rectangle, a trapezoid, and a mountain shape having a top formed of a straight line.

5. The hygroscopic material according to claim 1,
wherein a half-width of the cross section of a projection included in the support orthogonal to the plane direction of the support is in a range of 0.1 mm to 10 mm.

6. The hygroscopic material according to claim 1,
wherein the thickness of the thinnest portion of the support is in a range of 10 μm to 200 μm.

7. The hygroscopic material according to claim 1,
wherein the hygroscopic layer is a hygroscopic layer which has a porous structure containing amorphous silica particles, a water-soluble resin, and a hygroscopic agent.

8. The hygroscopic material according to claim 7,
wherein the water-soluble resin is polyvinyl alcohol having a degree of saponification of 99% or less and a degree of polymerization of 1500 or greater.

9. The hygroscopic material according to claim 1,
wherein the hygroscopic layer contains calcium chloride as a hygroscopic agent.

10. The hygroscopic material according to claim 1,
wherein a degree of moisture permeability of the resin layer having moisture permeability is in a range of 1 g/m²·day to 50 g/m²·day.

11. The hygroscopic material according to claim 7,
wherein the water-soluble resin is polyvinyl alcohol having a degree of saponification of 70% to 99% and a degree of polymerization of 1500 to 4500.

12. The hygroscopic material according to claim 7,
wherein a porosity of the porous structure in the hygroscopic layer is in a range of 45% to 85%.

13. A packaging material comprising:
the hygroscopic material according to claim 1.

14. A method of producing a hygroscopic material, comprising:
forming recesses in at least one surface of a resin sheet having moisture permeability by performing heat embossing to prepare a support having roughness;
forming a hygroscopic layer in at least recesses of one surface of the support; and
forming a damp-proof layer on the one surface of the support, on which the hygroscopic layer is formed.

15. The method of producing a hygroscopic material according to claim 14,
wherein the shape of a cross section of a projection included in the support, which is orthogonal to a plane direction of the support, is at least one selected from the group consisting of a triangle, a rectangle, a trapezoid, and a mountain shape having a top formed of a straight line.
